(19) United States
(12) Patent Application Publication
(10) Pub. No.: US 2016/0316395 A1
(43) Pub. Date: Oct. 27, 2016

(54) SERVICE QUERY METHOD, APPARATUS AND SYSTEM, AND STATION

(71) Applicant: Huawei Device Co., Ltd., Shenzhen (CN)

(72) Inventors: Ji Chen, Shenzhen (CN); Zhenguo Du, Shenzhen (CN); Zhiming Ding, Shenzhen (CN); Yunsong Yang, San Diego, CA (US); Ping Fang, Shenzhen (CN)

(21) Appl. No.: 15/197,146

(22) Filed: Jun. 29, 2016

Related U.S. Application Data
(63) Continuation of application No. PCT/CN2014/095665, filed on Dec. 30, 2014.

(30) Foreign Application Priority Data
Dec. 30, 2013 (CN) 201310746638.5
Jan. 18, 2014 (CN) 201410023919.2

(51) Int. Cl. H04W 28/12; H04W 48/20; H04W 40/24; H04L 29/08

(52) U.S. Cl. CPC H04W 28/12; H04L 67/16; H04W 48/20; H04L 67/1065; H04W 40/244; H04W 84/12

(57) ABSTRACT

A service query method includes: when receiving first service query request messages sent by multiple access points, where the first service query request message includes a station identity and requested service information, a service node sends query result information to only one or more access points thereof, namely a first access point, so as to send the query result information to a station corresponding to the station identity, and sends instruction information to another access point to instruct the another access point not to send the query result information.

### CROSS-REFERENCE TO RELATED APPLICATIONS

This application is a continuation of International Application No. PCT/CN2014/095665, filed on Dec. 30, 2014, which claims priority to Chinese Patent Application No. 201310746638.5, filed on Dec. 30, 2013, and Chinese Patent Application No. 201410023919.2, filed on Jan. 18, 2014, all of which are hereby incorporated by reference in their entireties.

### TECHNICAL FIELD

The present invention relates to the field of communications technologies, and in particular, to a service query method, apparatus and system, and a station.

### BACKGROUND

A Wireless Fidelity (WiFi) technology is widely applied in many electronic devices such as notebook computers, tablet computers, and mobile phones. A network structure of the Wireless Fidelity technology includes an infrastructure type and a peer-to-peer network connection type. In our daily life, the infrastructure type is commonly used.

A WiFi network structure of the infrastructure type includes an access point (AP), a station (STA), and a server. Multiple stations may be connected to the access point, and use services provided by the access point, such as a network connection. Generally, the access point mainly provides WiFi-level services. The access point may further provide services such as networks and upper-layer applications.

After finding an access point, a station wants to know services that can be provided by the access point. In the prior art, a generic advertisement service (GAS) is used for query. That is, the station sends a GAS query request message to the access point; after receiving the message, the access point extracts query request content carried in the message and forwards the query request content to a server for interpretation; the server returns query result content to the access point; and the access point then sends the query result content to the station by adding the query result content to a GAS query response message. However, coverage areas of access points deployed in a network may mutually overlap. Therefore, a GAS query request message sent by a station may be received by multiple access points. After these access points forward query request content according to the GAS query request message, same content is repeatedly transmitted between the server and the station, thereby wasting resources for transmitting information between the station and the server.

### SUMMARY

Embodiments of the present invention provide a service query method, apparatus and system, and a station, which reduce data transmitted between a station and a service node.

A first aspect of an embodiment of the present invention provides a service query method, including:

receiving, by a service node, a first service query request message sent by at least one access point, where the first service query request message includes a station identity and requested service information;

determining, by the service node, a first access point according to the at least one access point;

sending, by the service node, query result information to the first access point, so that the first access point sends the query result information to a station corresponding to the station identity, where the query result information is obtained by the service node according to the requested service information in the first service query request message; and

when the at least one access point includes multiple access points, sending instruction information to another access point than the first access point in the at least one access point, where the instruction information is used for instructing the another access point not to send the query result information.

In a first possible implementation manner of the first aspect of the embodiment of the present invention:

the sending query result information to the first access point, so that the first access point sends the query result information to a station corresponding to the station identity specifically includes: sending a first service query response message to the first access point, where the first service query response message includes the query result information, so that the first access point sends the query result information to the station according to the first service query response message; and

the sending instruction information to another access point than the first access point in the at least one access point specifically includes: sending a second service query response message to the another access point, where the second service query response message includes the instruction information, and the instruction information is used for instructing the another access point not to send the query result information, so that the another access point does not send the query result information according to the second service query response message.

With reference to the first aspect of the embodiment of the present invention or the first possible implementation manner of the first aspect, in a second possible implementation manner of the first aspect of the embodiment of the present invention:

if the first service query request message further includes: load indication information of the access point, and/or signal strength indication information of receiving a query request message by the access point, the determining, by the service node, a first access point in the at least one access point specifically includes: determining the first access point according to the signal strength indication information and/or the load indication information.

With reference to the first aspect of the embodiment of the present invention or the first possible implementation manner of the first aspect, in a third possible implementation manner of the first aspect of the embodiment of the present invention:

if the first service query request message further includes a session identity, the sending, by the service node, query result information to the first access point specifically includes: sending the session identity and the query result information to the first access point, so that the first access point sends the query result information to the station in response to a query request message corresponding to the session identity, where

the query request message is sent by the station and received by the first access point.

With reference to the first aspect of the embodiment of the present invention or any one of the first to third possible implementation manners of the first aspect, in a fourth possible implementation manner of the first aspect of the embodiment of the present invention, the method further includes:

storing, by the service node, the first service query request message and/or the query result information; and

when the service node receives a second service query request message that is sent by the station by using a second access point, if requested service information in the second service query request message is consistent with the requested service information in the stored first service query request message, or if query result information of the second service query request message is consistent with the stored query result information, sending, by the service node, the instruction information to the second access point, where the instruction information is used for instructing the second access point not to send the query result information to the station.

A second aspect of an embodiment of the present invention provides a service query method, including:

receiving, by a station, connection information sent by an access point, where the connection information includes a service node identity;

determining, by the station, at least one query access point according to one or more access points that send the connection information, where the connection information sent by the multiple access points includes a same service node identity; and sending, by the station, a query request message to the at least one query access point, where the query request message includes a station identity of the station and requested service information, so that the at least one query access point performs service query according to the query request message.

In a first possible implementation manner of the second aspect of the embodiment of the present invention, the receiving, by a station, connection information sent by an access point specifically includes:

receiving, by the station, a beacon frame sent by the access point, where the beacon frame includes identity information of a service node connected to the access point; or

receiving, by the station, a probe response frame that is sent by the access point in response to a probe request frame, where the probe response frame includes identity information of a service node connected to the access point.

With reference to the second aspect of the embodiment of the present invention or the first possible implementation manner of the second aspect, in a second possible implementation manner of the second aspect of the embodiment of the present invention, the sending, by the station, a query request message to the at least one query access point specifically includes:

sending, by the station, the query request message to the at least one query access point in a unicast manner, so that the at least one query access point sends query result information to the station; or

sending, by the station, the query request message in a multicast or broadcast manner, where the query request message further includes a bit table, and using bit information that is corresponding to the at least one query access point and in the bit table to indicate performing service query, where the bit table includes bit information corresponding to the one or more access points.

With reference to the second possible implementation manner of the second aspect of the embodiment of the present invention, in a third possible implementation manner of the second aspect of the embodiment of the present invention, the bit information that is corresponding to the at least one query access point and in the bit table is information that is obtained according to address information of the at least one query access point by using a hash algorithm.

With reference to the second aspect of the embodiment of the present invention or any one of the first to third possible implementation manners of the second aspect, in a fourth possible implementation manner of the second aspect of the embodiment of the present invention, the method further includes:

receiving, by the service node, a first service query request message sent by the at least one query access point, where the first service query request message includes the station identity and the requested service information, and the first service query request message is sent by the at least one query access point according to the query request message;

determining, by the service node, a first access point according to the at least one query access point;

sending, by the service node, a first service query response message to the first access point, where the first service query response message includes the query result information, so that the first access point sends, according to the first service query response message, the query result information to the station corresponding to the station identity, where the query result information is obtained by the service node according to the requested service information in the first service query request message; and

when the at least one query access point is multiple query access points, sending a second service query response message to another access point than the first access point in the multiple query access points, where the second service query response message includes instruction information, and the instruction information is used for instructing the another access point not to send the query result information, so that the another access point does not send the query result information according to the second service query response message.

With reference to the second aspect of the embodiment of the present invention or any one of the first to fourth possible implementation manners of the second aspect, in a fifth possible implementation manner of the second aspect of the embodiment of the present invention, the method further includes:

storing, by the service node, the first service query request message and/or the query result information; and

when the service node receives a second service query request message that is sent by the station by using a second access point, if requested service information in the second service query request message is consistent with the requested service information in the stored first service query request message, or if query result information of the second service query request message is consistent with the stored query result information, sending, by the service node to the second access point, the instruction information of not sending the query result information.

A third aspect of an embodiment of the present invention provides a service query method, including:

sending, by an access point, a first service query request message to a service node, where the first service query request message includes a station identity and requested service information;

when receiving query result information sent by the service node, sending, by the access point, the query result information to a station corresponding to the station identity, where the query result information is obtained by the service node according to the requested service information in the first service query request message; and

if receiving instruction information sent by the service node, where the instruction information is used for instructing the access point not to send the query result information, skipping sending, by the access point, the query result information, or sending information other than the query result information to the station.

In a first possible implementation manner of the third aspect of the embodiment of the present invention:

the first service query request message further includes: load indication information of the access point, and/or signal strength indication information of receiving a query request message by the access point, so that the service node determines, according to the signal strength indication information and/or the load indication information, an access point that sends the query result information; and/or

the first service query request message further includes a session identity, and when the access point receives the query result information and the session identity that are sent by the service node, the sending the query result information to a station corresponding to the station identity specifically includes: sending the query result information to the station in response to a query request message corresponding to the session identity.

With reference to the third aspect of the embodiment of the present invention or the first possible implementation manner of the third aspect, in a second possible implementation manner of the third aspect of the embodiment of the present invention, before the sending, by an access point, a first service query request message to a service node, the method further includes:

sending, by the access point, connection information to the station, where the connection information includes a service node identity.

With reference to the second possible implementation manner of the third aspect of the embodiment of the present invention, in a third possible implementation manner of the third aspect of the embodiment of the present invention, the sending, by the access point, connection information to the station specifically includes:

sending, by the access point, a beacon frame, where the beacon frame includes identity information of a service node connected to the access point; or

when receiving a probe request frame sent by the station, sending, by the access point, a probe response frame to the station, where the probe response frame includes identity information of a service node connected to the access point.

With reference to the second or third possible implementation manner of the third aspect of the embodiment of the present invention, in a fourth possible implementation manner of the third aspect of the embodiment of the present invention, after the sending, by the access point, connection information to the station, the method further includes:

after the access point receives the query request message that is sent by the station in a unicast manner, performing the step of sending, by an access point, a first service query request message to a service node; or

receiving, by the access point, the query request message that is sent by the station in a multicast or broadcast manner, where the query request message further includes a bit table, and the bit table includes bit information corresponding to one or more access points; and

if bit information that is corresponding to the access point and in the bit table indicates performing service query, performing the step of sending, by an access point, a first service query request message to a service node.

With reference to the fourth possible implementation manner of the third aspect of the embodiment of the present invention, in a fifth possible implementation manner of the third aspect of the embodiment of the present invention, the bit information that is corresponding to the access point and in the bit table is information that is obtained by the station according to address information of the access point by using a hash algorithm.

A fourth aspect of an embodiment of the present invention provides a service query method, including:

sending, by an access point, connection information to a station, where the connection information includes a service node identity, so that the station determines at least one query access point according to one or more access points that send the connection information, and sends a query request message, where the connection information sent by the multiple access points includes a same service node identity;

receiving, by the access point, the query request message sent by the station, where the query request message includes a station identity of the station and requested service information; and

if the access point is the query access point determined by the station, performing, by the station, service query according to the query request message.

In a first possible implementation manner of the fourth aspect of the embodiment of the present invention, the sending, by an access point, connection information to a station specifically includes:
sending, by the access point, a beacon frame, where the beacon frame includes identity information of a service node connected to the access point; or

when receiving a probe request frame sent by the station, sending, by the access point, a probe response frame to the station in response to the probe request frame, where the probe response frame includes identity information of a service node connected to the access point.

With reference to the fourth aspect of the embodiment of the present invention or the first possible implementation manner of the fourth aspect, in a second possible implementation manner of the fourth aspect of the embodiment of the present invention, the receiving, by the access point, the query request message sent by the station specifically includes:

receiving, by the access point, the query request message that is sent by the station in a unicast manner, and performing the step of performing service query according to the query request message; or

receiving, by the access point, the query request message that is sent by the station in a multicast or broadcast manner, where the query request message further includes a bit table, and if bit information that is corresponding to the access point and in the bit table indicates performing service query, performing the step of performing service query according to the query request message, where the bit table includes bit information corresponding to one or more access points.

With reference to the second possible implementation manner of the fourth aspect of the embodiment of the present invention, in a third possible implementation manner of the fourth aspect of the embodiment of the present invention, the bit information that is corresponding to the access point and in the bit table is information that is obtained by the station according to address information of the access point by using a hash algorithm.

A fifth aspect of an embodiment of the present invention provides a service query apparatus, including:

a request receiving unit, configured to receive a first service query request message sent by at least one access point, where the first service query request message includes a station identity and requested service information;

a node determining unit, configured to determine a first access point according to the at least one access point;

a result sending unit, configured to send query result information to the first access point determined by the node determining unit, so that the first access point sends the query result information to a station corresponding to the station identity, where the query result information is obtained by the service query apparatus according to the requested service information in the first service query request message received by the request receiving unit; and

an instruction sending unit, configured to: if the at least one access point includes multiple access points, send instruction information to another access point than the first access point determined by the node determining unit in the at least one access point, where the instruction information is used for instructing the another access point not to send the query result information.

In a first possible implementation manner of the fifth aspect of the embodiment of the present invention:

the result sending unit is specifically configured to send a first service query response message to the first access point, where the first service query response message includes the query result information, so that the first access point sends the query result information to the station according to the first service query response message; and

the instruction sending unit is specifically configured to send a second service query response message to the another access point, where the second service query response message includes the instruction information, and the instruction information is used for instructing the another access point not to send the query result information, so that the another access point does not send the query result information according to the second service query response message.

With reference to the fifth aspect of the embodiment of the present invention or the first possible implementation manner of the fifth aspect, in a second possible implementation manner of the fifth aspect of the embodiment of the present invention:

if the first service query request message received by the request receiving unit further includes: load indication information of the access point and/or signal strength indication information of receiving a query request message by the access point,

the node determining unit is specifically configured to determine the first access point according to the signal strength indication information and/or the load indication information included in the first service query request message received by the request receiving unit.

With reference to the fifth aspect of the embodiment of the present invention or the first possible implementation manner of the fifth aspect, in a third possible implementation manner of the fifth aspect of the embodiment of the present invention:

if the first service query request message received by the request receiving unit further includes a session identity,

the result sending unit is specifically configured to send the session identity in the first service query request message received by the request receiving unit and the query result information to the first access point, so that the first access point sends the query result information to the station in response to a query request message corresponding to the session identity, where the query request message is sent by the station and received by the first access point.

With reference to the fifth aspect of the embodiment of the present invention or any one of the first to third possible implementation manners of the fifth aspect, in a fourth possible implementation manner of the fifth aspect of the embodiment of the present invention, the apparatus further includes:

a storing unit, configured to store the first service query request message and/or the query result information; where

the request receiving unit is further configured to receive a second service query request message that is sent by the station by using a second access point; and

the instruction sending unit is further configured to: if requested service information in the second service query request message received by the request receiving unit is consistent with the requested service information in the stored first service query request message, or if query result information of the second service query request message is consistent with the stored query result information, send the instruction information to the second access point, where the instruction information is used for instructing the second access point not to send the query result information to the station.

A sixth aspect of an embodiment of the present invention provides a station, including:

a connection information receiving unit, configured to receive connection information sent by an access point, where the connection information includes a service node identity;

a query node determining unit, configured to determine a query access point according to one or more access points that send the connection information, where the connection information sent by the multiple access points includes a same service node identity; and

a query request sending unit, configured to send a query request message to the at least one query access point determined by the query node determining unit, where the query request message includes a station identity of the station and requested service information, so that the at least one query access point performs service query according to the query request message.

In a first possible implementation manner of the sixth aspect of the embodiment of the present invention:

the connection information receiving unit is specifically configured to receive a beacon frame sent by the access point, where the beacon frame includes identity information of a service node connected to the access point; or

the connection information receiving unit is specifically configured to receive a probe response frame that is sent by the access point in response to a probe request frame, where the probe response frame includes identity information of a service node connected to the access point.

With reference to the sixth aspect of the embodiment of the present invention or the first possible implementation manner of the sixth aspect, in a second possible implementation manner of the sixth aspect of the embodiment of the present invention:

the query request sending unit is specifically configured to send the query request message to the at least one query access point in a unicast manner, so that the at least one query access point sends query result information to the station; or

the query request sending unit is specifically configured to: send the query request message in a multicast or broadcast manner, where the query request message further includes a bit table; and use bit information that is corresponding to the at least one query access point and in the bit table to indicate sending query result information, where the bit table includes bit information corresponding to one or more access points.

With reference to the second possible implementation manner of the sixth aspect of the embodiment of the present invention, in a third possible implementation manner of the sixth aspect of the embodiment of the present invention, the bit information that is corresponding to the at least one query access point and in the bit table included in the query request message sent by the query request sending unit is information that is obtained according to address information of the at least one query access point by using a hash algorithm.

A seventh aspect of an embodiment of the present invention provides a service query apparatus, including:

a request sending unit, configured to send a first service query request message to a service node, where the first service query request message includes a station identity and requested service information;

a result reply unit, configured to: when query result information sent by the service node is received, send the query result information to a station corresponding to the station identity, where the query result information is obtained by the service node according to the requested service information in the first service query request message sent by the request sending unit; and

an instruction reply unit, configured to: if instruction information sent by the service node is received, where the instruction information is used for instructing the service query apparatus not to send the query result information, skip sending the query result information, or send information other than the query result information to the station.

In a first possible implementation manner of the seventh aspect of the embodiment of the present invention:

the first service query request message sent by the request sending unit further includes: load indication information of the service query apparatus and/or signal strength indication information of receiving a query request message by the service query apparatus, so that the service node determines, according to the signal strength indication information and/or the load indication information, an access point that sends the query result information; and/or

the first service query request message sent by the request sending unit further includes a session identity, and the result reply unit is specifically configured to: when the query result information and the session identity that are sent by the service node are received, send the query result information to the station in response to a query request message corresponding to the session identity.

With reference to the seventh aspect of the embodiment of the present invention or the first possible implementation manner of the seventh aspect, in a second possible implementation manner of the seventh aspect of the embodiment of the present invention:

a connection sending unit, configured to send connection information to the station, where the connection information includes a service node identity.

With reference to the second possible implementation manner of the seventh aspect of the embodiment of the present invention, in a third possible implementation manner of the seventh aspect of the embodiment of the present invention:

the connection sending unit is specifically configured to send a beacon frame, where the beacon frame includes identity information of a service node connected to the service query apparatus; or

the connection sending unit is specifically configured to: when a probe request frame sent by the station is received, send a probe response frame to the station, where the probe response frame includes identity information of a service node connected to the service query apparatus.

With reference to the second or third possible implementation manner of the seventh aspect of the embodiment of the present invention, in a fourth possible implementation manner of the seventh aspect of the embodiment of the present invention, the apparatus further includes: a query request receiving unit, where

the query request receiving unit is configured to receive the query request message that is sent by the station in a unicast manner, or configured to receive the query request message that is sent by the station in a multicast or broadcast manner, where the query request message further includes a bit table, and the bit table includes bit information corresponding to one or more access points; and

the request sending unit is specifically configured to: after the query request receiving unit receives the query request message that is sent in the unicast manner, perform the step of sending a first service query request message to a service node, or configured to: if bit information that is corresponding to the service query apparatus and in the bit table included in the query request message received by the query request receiving unit indicates performing service query, perform the step of sending a first service query request message to a service node.

With reference to the fourth possible implementation manner of the seventh aspect of the embodiment of the present invention, in a fifth possible implementation manner of the seventh aspect of the embodiment of the present invention, the bit information that is corresponding to the service query apparatus and in the bit table included in the query request message received by the query request receiving unit is information that is obtained by the station according to address information of the service query apparatus by using a hash algorithm.

An eighth aspect of an embodiment of the present invention provides a service query apparatus, including:

a connection information sending unit, configured to send connection information to a station, where the connection information includes a service node identity, so that the station determines at least one query access point according to one or more access points that send the connection information, and sends a query request message, where the connection information sent by the multiple access points includes a same service node;

a query request receiving unit, configured to receive the query request message sent by the station, where the query request message includes a station identity of the station and requested service information; and

a query unit, configured to: if the service query apparatus is the query access point determined by the station, perform service query according to the query request message received by the query request receiving unit.

In a first possible implementation manner of the eighth aspect of the embodiment of the present invention:

the connection information sending unit is specifically configured to send a beacon frame, where the beacon frame includes identity information of a service node connected to the service query apparatus; or

the connection information sending unit is specifically configured to: when a probe request frame sent by the station is received, send a probe response frame to the station in response to the probe request frame, where the probe response frame includes identity information of a service node connected to the service query apparatus.

With reference to the eighth aspect of the embodiment of the present invention or the first possible implementation manner of the eighth aspect, in a second possible implementation manner of the eighth aspect of the embodiment of the present invention:

the query request receiving unit is specifically configured to: receive the query request message that is sent by the station in a unicast manner, and instruct the query unit to perform the step of performing service query according to the query request message; or

the query request receiving unit is specifically configured to: receive the query request message that is sent by the station in a multicast or broadcast manner, where the query request message further includes a bit table, and if bit information that is corresponding to the service query apparatus and in the bit table indicates performing service query, instruct the query unit to perform the step of performing service query according to the query request message, where the bit table includes bit information corresponding to one or more access points.

With reference to the second possible implementation manner of the eighth aspect of the embodiment of the present invention, in a third possible implementation manner of the eighth aspect of the embodiment of the present invention, the bit information that is corresponding to the service query apparatus and in the bit table is information that is obtained by the station according to address information of the service query apparatus by using a hash algorithm.

A ninth aspect of an embodiment of the present invention provides a service query system, including multiple access points and a service node, where

the service node is the service query apparatus described in the fifth aspect of the embodiment of the present invention or any one of the first to fourth possible implementation manners of the first aspect; and

the access point is the service query apparatus described in the seventh aspect of the embodiment of the present invention or the first possible implementation manner of the seventh aspect.

In a first possible implementation manner of the ninth aspect of the embodiment of the present invention, the service node and one access point of the multiple access points are deployed on a same physical device, or are deployed on different physical devices.

A tenth aspect of an embodiment of the present invention provides a service query system, including a station, multiple access points, and a service node, where

the station is the station described in the sixth aspect of the embodiment of the present invention or any one of the first to third possible implementation manners of the sixth aspect; and

the access point is the service query apparatus described in the eighth aspect of the embodiment of the present invention or any one of the first to third possible implementation manners of the eighth aspect.

In a first possible implementation manner of the tenth aspect of the embodiment of the present invention, the service node is the service query apparatus described in the fifth aspect of the embodiment of the present invention or any one of the first to fourth possible implementation manners of the fifth aspect; and

the access point is the service query apparatus described in any one of the second to fifth possible implementation manners of the seventh aspect of the embodiment of the present invention.

With reference to the tenth aspect of the embodiment of the present invention or the first possible implementation manner of the tenth aspect, in a second possible implementation manner of the tenth aspect of the embodiment of the present invention, the service node and one access point of the multiple access points are deployed on a same physical devices, or are deployed on different physical devices.

It can be seen that in the service query method in the embodiments of the present invention, when receiving first service query request messages sent by multiple access points, where the first service query request message includes a station identity and requested service information, a service node sends query result information to only one or more access points thereof, namely a first access point, so that the first access point sends the query result information to a station corresponding to the station identity, and sends instruction information to another access point to instruct the another access point not to send the query result information. In this way, after the service node receives service query request messages that are from a same station and used for requesting same service information, the service node does not repeatedly send query result information to all access points to reply to the station, but selects one or more access points to reply to the station with the query result information, thereby reducing data that is transmitted between the station and the service node by using the access points, and reducing transmission resources.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1a and FIG. 1b are schematic structural diagrams of a service query system according to an embodiment of the present invention;

FIG. 2 is a flowchart of a service query method according to Method Embodiment 1 of the present invention;

FIG. 3 is a flowchart of another service query method according to Method Embodiment 1 of the present invention;

FIG. 4 is a flowchart of a service query method according to Method Embodiment 2 of the present invention;

FIG. 5 is a flowchart of a service query method according to Method Embodiment 3 of the present invention;

FIG. 6 is a flowchart of another service query method according to Method Embodiment 3 of the present invention;

FIG. 7 is a flowchart of a service query method according to Method Embodiment 4 of the present invention;

FIG. 8 is a flowchart of a service query method according to Method Embodiment 5 of the present invention;

FIG. 9 is a flowchart of a service query method according to Method Embodiment 6 of the present invention;

FIG. 10a is a flowchart of another service query method according to Method Embodiment 6 of the present invention;

FIG. 10b is a flowchart of another service query method according to Method Embodiment 6 of the present invention;

FIG. 11 is a schematic structural diagram of a service query apparatus according to Device Embodiment 1 of the present invention;

FIG. 12 is a schematic structural diagram of a station according to Device Embodiment 2 of the present invention;

FIG. 13 is a schematic structural diagram of a service query apparatus according to Device Embodiment 3 of the present invention;

FIG. 14 is a schematic structural diagram of another service query apparatus according to Device Embodiment 3 of the present invention;

FIG. 15 is a schematic structural diagram of a service query apparatus according to Device Embodiment 4 of the present invention;

FIG. 16 is a schematic structural diagram of a service query apparatus according to Device Embodiment 4 of the present invention;

FIG. 17 is a schematic structural diagram of a station according to Device Embodiment 5 of the present invention;

FIG. 18 is a flowchart of a service query method according to Method Embodiment 7 of the present invention;

FIG. 19 is a flowchart of another service query method according to Method Embodiment 7 of the present invention;

FIG. 20 is a flowchart of another service query method according to Method Embodiment 7 of the present invention;

FIG. 21 is a flowchart of a service query method according to Method Embodiment 8 of the present invention;

FIG. 22 is a flowchart of another service query method according to Method Embodiment 8 of the present invention;

FIG. 23 is a schematic structural diagram of a station according to Device Embodiment 9 of the present invention;

FIG. 24 is a schematic structural diagram of a service query apparatus according to Device Embodiment 9 of the present invention;

FIG. 25 is a schematic structural diagram of a station according to Device Embodiment 10 of the present invention;

FIG. 26 is a schematic structural diagram of a station according to Device Embodiment 11 of the present invention;

FIG. 27 is a schematic structural diagram of a service query apparatus according to Device Embodiment 12 of the present invention; and

FIG. 28 is a schematic structural diagram of a station according to Device Embodiment 13 of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

### Method Embodiment 1 of the Present Invention

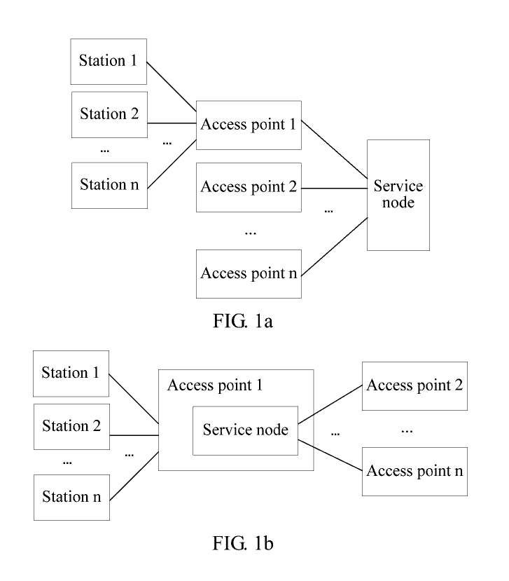

A service query method is provided, and may be mainly applied to service query systems shown in FIG. 1a and FIG. 1b. The system shown in FIG. 1a includes a station, multiple access points, and a service node. Multiple stations may be connected to one access point, and the multiple access points may be connected to one service node. The multiple access points and the service node are deployed on different physical devices. The service node may provide a service query function, and various services, such as an Internet access service and a printer service provided by a current network or provided by using a current network may be queried. Specifically, the services may be provided by a device where the service node is located, or may be provided by another dedicated device. For example, the Internet access service may be provided by a device where the service node is located, and the printer service may be provided by a dedicated printer in a network.

The system shown in FIG. 1b includes a station and multiple access points. A service node is further deployed in one access point (for example, an access point 1 in FIG. 1b) of the multiple access points. The service node has a similar function to the service node in the foregoing system shown in FIG. 1a. The service node may provide network upper-level services, for example, both an access point of “ChinaNet” deployed by a China Telecom business hall and an access point of “ChinaUnicom” deployed by a China Unicom business hall may have a service node each for providing an Internet access service. Multiple stations may be connected to one access point, and multiple access points may be connected to a service node of the access point 1 in the system.

In this embodiment of the present invention, when service query is performed, a WiFi-level association relationship may have been or may still not be established between a station and an access point. An access point and a service node are two logic entities. The service node may be a specific physical device (as shown in FIG. 1a) in a network, where the service node is connected to the access point in a wired or wireless manner; or may be a software entity running on an access point, where the software entity implements a function of the service node (as shown in FIG. 1b). The service node provides a service query function.

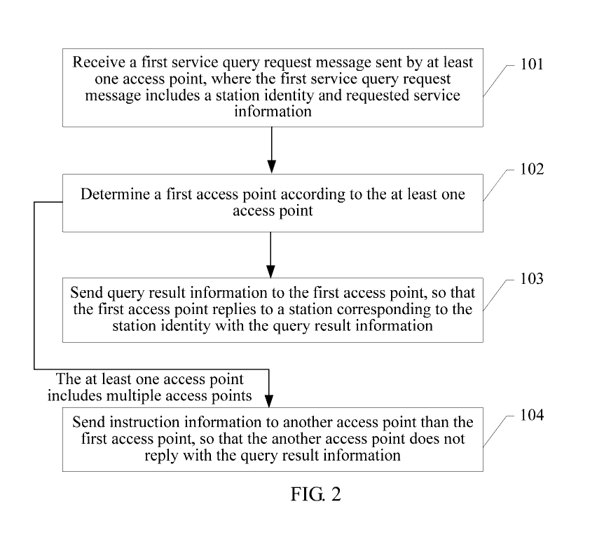

The method in this embodiment is a method executed by a service node in a service query system (for example, the service node shown in FIG. 1a, or the service node included in the access point shown in FIG. 1b). A flowchart is shown in FIG. 2, and the method includes:

Step 101. Receive a first service query request message sent by at least one access point, where the first service query request message includes a station identity and requested service information, the requested service information may be service information that can be provided by a service node, and the at least one access point is connected to the service node.

It may be understood that if a station needs to know what services can be provided by a network where an access point is located, a query may be first performed by using the access point. The station sends a query request message to the access point, where the query request message includes a station identity of the station and requested service information, and may further include a session identity that uniquely identifies a current query session; and after receiving the query request message, the access point may extract the station identity, the requested service information, and the like thereof, adds the extracted information to a first service query request message, and sends the first service query request message to the service node. If the service node and the access point belong to different physical devices (as shown in FIG. 1a), the first service query request message is transmitted between the service node and the access point in a wired or wireless manner, and in this case, the transmission may be performed based on an upper-level IP protocol; if the service node and the access point are located on a same physical device (as shown in FIG. 1b), the first service query request message is transmitted by using a communication channel inside the device.

It should be noted that essentially, the query request message sent by the station and the service query request message are both used for querying service information, and a difference is that the query request message is sent by the station to the access point, while the service query request message is sent by the access point to the service node in response to the query request message sent by the station.

Step 102. Determine a first access point according to the at least one access point. If the at least one access point has only one access point, the access point is the first access point, and, the service node only performs step 103. When the at least one access point includes multiple access points, the service node further needs to perform step 104 in addition to needing to perform step 103, and in this case, the service node may select one or more access points thereof as the first access point according to actual conditions (for example, load conditions) of the multiple access points, that is, there may be one or more first access points.

Step 103. Send query result information to the first access point, so that the first access point sends the query result information to a station corresponding to the station identity, where the query result information is obtained by the service node according to the requested service information in the first service query request message.

Specifically, the service node may return a first service query response message to the first access point, where the first service query response message includes the query result information, so that the first access point can extract the query result information, and can send the query result information to the station by adding the query result information to a query response message. If the service node and the access point belong to different physical devices (as shown in FIG. 1a), the first service query response message is transmitted between the service node and the access point in a wired or wireless manner; if the service node and the access point are located on a same physical device (as shown in FIG. 1b), the first service query response message is transmitted by using a communication channel inside the device.

For a case in which the at least one access point has multiple access points, after receiving a first service query request message sent by an access point and acquiring query result information, the service node may not first determine the first access point or send the query result information, but collects statistics on whether a station identity and requested service information that are included in a service query request message sent by another access point and received within a preset time is consistent with the station identity and the requested service information that are included in the first service query request message. If consistent, it is regarded that the another access point also sends the first service query request message for the same station, and the service node may select the first access point only after the preset time expires, and sends the acquired query result information to the first access point.

Step 104. Send instruction information to another access point than the first access point in the at least one access point, where the instruction information is used for instructing the another access point not to send the query result information.

Specifically, the service node may return a second service query response message to the another access point, where the second service query response message includes the instruction information, to instruct the another access point not to send the query result information. In this way, the another access point does not send the query result information to the station according to the instruction information in the second service query response message. In this case, if the service node adds other information, for example, information about all access points that send the first service query request message (indicating that these access points are connected to one service node), to the second service query response message when sending the second service query response message, the another access point returns the information about all access points to the station by using a query response message, so that the station can know the information about all access points connected to the service node. If a connection with the first access point is not smooth, the another access point may be used for network connection. In other cases, the instruction information may further instruct the service node not to send the query result information to the another access point. In this way, after receiving the instruction information, the another access point knows that the query result information does not need to be sent to user equipment.

It can be seen that in this embodiment, when receiving first service query request messages sent by multiple access points, where the first service query request message includes a station identity and requested service information, a service node sends query result information to only one or more first access points thereof, so as to send the query result information to a station corresponding to the station identity, and sends instruction information to another access point to instruct the another access point not to send the query result information. In this way, after the service node receives service query request messages that are from a same station and used for requesting same service information, the service node does not repeatedly send query result information to all access points to reply to the station, but selects one or more access points to reply to the station with the query result information, thereby reducing data that is transmitted between the station and the service node by using the access points, and reducing transmission resources.

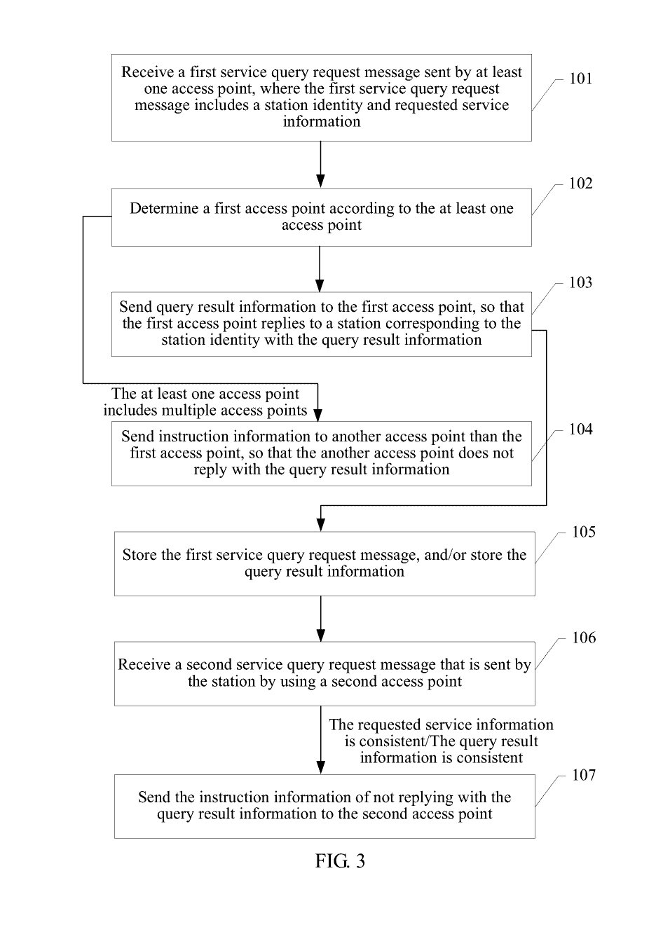

Referring to FIG. 3, in a specific embodiment, in addition to performing the foregoing steps 101 to 104, the service node may further perform the following steps 105 to 107. Specifically:

Step 105. Store the first service query request message received in the foregoing step 101, and/or store the query result information. When the first service query request message is stored, correspondingly, the station identity also needs to be saved, so as to know that this query is a query from which station. The storing in this step 105 may be performed after the foregoing step 101, or may be performed after the query result information is obtained according to the first service query request message. What is shown in the foregoing FIG. 3 is only a specific implementation scheme thereof.

Step 106. Receive a second service query request message that is sent by the station by using a second access point.

It may be understood that each station and each access point have their own wireless working channels. When a station communicates with an access point, the station and the access point need to be on a same wireless working channel. The station may initiate, on a different wireless working channel, the query request message to an access point that works on the corresponding wireless working channel to query service information of a service node corresponding to the access point. When the station initiates a query request message on another wireless working channel after initiating a query request message on a wireless working channel, the service node further receives, after performing the foregoing steps 101 to 103, a second service query request message sent by a second access point that works on the another wireless working channel, and therefore first determines whether corresponding query result information has been sent, on the previous wireless working channel, to the access point on the previous channel. Specifically, if requested service information in the second service query request message is consistent with the requested service information in the first service query request message stored in step 105, the query result information does not need to be returned to the second access point, and step 107 is performed; or if the query result information of the second service query request message is consistent with the stored query result information, the query result information does not need to be returned to the second access point, and step 107 is performed.

Step 107. Send the instruction information to the second access point, where the instruction information is used for instructing the second access point not to send the query result information to the station. Specifically, the service node may send a service query response message corresponding to the second service query request message to the second access point, where the service query response message carries the instruction information for instruction.

It should be noted that the “first” and “second” in this specification are merely used for mutual distinguishing, and do not have other specific meanings.

In another specific embodiment, after a station sends a query request message to an access point, in addition to sending a station identity and requested service information to a service node by adding the station identity and the requested service information to a first service query request message, the access point may further add other information to the first service query request message. Specifically, the first service query request message that is received by the service node in the foregoing step 101 may further include: load indication information of the access point, where the load indication information is used for indicating a condition of a station accessed by the access point, so that a saturation degree of current workload of the access point can be known; and/or signal strength indication information (received signal strength indicator, RSSI) of receiving the query request message by the access point, where the signal strength indication information is used for indicating signal strength of receiving, by the access point, the query request message initiated by the station, so that a rough route between the station and the access point can be known with reference to power at which the station sends the query request message. Therefore, when performing the foregoing step 102, the service node may specifically determine the first access point according to the signal strength indication information and/or the load indication information, for example, select an access point with a small workload saturation degree as the first access point, or select an access point that has a relatively short route to the station as the first access point.

In addition, the access point may receive multiple query request messages sent by multiple stations. In this way, the first service query request message may further include a session identity that is used for identifying a query request message of a station corresponding to the first service query request message. Therefore, when performing the foregoing step 103, the service node specifically sends the session identity and the query result information to the first access point, so that the first access point sends the query result information to the station in response to the query request message corresponding to the session identity; and when performing the foregoing step 104, sends the session identity and the instruction information to the another access point, so that the another access point does not send the query result information in response to the query request message corresponding to the session identity. In addition, the session identity may also be used in a phase from the foregoing step 105 to step 107. The service node saves the session identity in step 105. When whether the requested service information is consistent is determined before step 107 is performed, the determining may be performed according to the station identity, the session identity, and the requested service information together.

### Method Embodiment 2 of the Present Invention

A service query method is provided, and may be mainly applied to the service query systems shown in the foregoing FIG. 1a and FIG. 1b. The method in this embodiment is a method executed by a station in the system, and a difference between the method in this embodiment and the method in the foregoing Embodiment 1 is that data that is transmitted between a station and a service node by using an access point is reduced by means of a station side in this embodiment, while data that is transmitted between a station and a service node by using an access point is reduced by means of a network side (service node) in the foregoing Embodiment 1. A flowchart is shown in FIG. 4, and the method includes:

Step 201. Receive connection information sent by an access point, where the connection information includes a service node identity.

It may be understood that in a process of discovering an access point by a station, the station may receive a beacon frame (beacon) that is actively sent by the access point by means of broadcasting, where the beacon frame may carry the connection information in this embodiment; or the station may actively send a probe request (probe request) frame by means of broadcasting, where in this embodiment, after receiving the probe request frame, the access point may add the connection information to a probe response (probe response) frame to be returned to the station.

Therefore, in this embodiment, when the station receives the beacon frame sent by the access point, where the beacon frame includes identity information, namely a service node identity, of a service node connected to the access point, or when the station receives a probe response frame that is sent by the access point in response to the probe request frame, where the probe response frame includes identity information of a service node connected to the access point, the station obtains the connection information of the access point.

Step 202. Determine at least one query access point according to one or more access points that send the connection information, where there may be one or more query access points, and the connection information sent by the multiple access points includes a same service node identity. Herein, that the connection information includes a same service node identity may mean that service node identities in connection information sent by two access points are completely the same, or may mean that connection information sent by two access points includes at least one same service node identity.

Step 203. Send a query request message to the at least one query access point, where the query request message includes a station identity of the station and requested service information, so that the at least one query access point performs service query according to a service query request message. When receiving the query request message, the at least one query access point may send the first service query request message in the foregoing Method Embodiment 1 to a service node according to the query request message, and the service node may perform service query according to the method in the foregoing Method Embodiment 1. Details are not described herein again. Especially when multiple query access points are determined in the foregoing step 202, the service node may receive first service query request messages sent by the multiple query access points. In this way, the service node may select, from the multiple query access points, a query access point that needs to send query result information to the station. The service node may select one or more query access points from the multiple query access points to send the query result information.

When specifically performing this step, the station may send the query request message to the at least one query access point in a unicast manner, so that the at least one query access point sends the query result information to the station; or send the query request message in a multicast or broadcast manner, where however, the query request message further needs to include a bit table in addition to including the station identity and the requested service information, and the bit table may be a Bloom Filter (Bloom Filter); and use bit information that is corresponding to the at least one query access point and in the bit table to instruct a corresponding query access point to perform service query, where the bit table may include bit information corresponding to one or more access points.

Bit information of each access point in the bit table may be a simple string of 0s or 1s. The bit information of each access point may be corresponding to one or more bits. When one access point is corresponding to one bit, for example, an access point 1 is corresponding to the first bit and an access point 2 is corresponding to the second bit, and when the first bit is 1 and the second bit is 0, it indicates that the access point 1 needs to perform service query and the access point 2 does not need to perform service query. When one access point is corresponding to multiple bits, for example, an access point 1 is corresponding to the first bit and the tenth bit, and an access point 2 is corresponding to the second bit and the eighth bit, and when both the first bit and the tenth bit are 1, it indicates that the access point 1 performs service query; when the second bit is 1 and the eighth bit is 0, it indicates that the access point 2 does not need to perform service query.

In another specific scheme, bit information corresponding to a query access point in the bit table may be information that is obtained according to address information of the query access point by using a hash algorithm. Specifically, the station may obtain the information by directly performing hash calculation on the address information of the query access point or by truncating a part of address information and then performing hash calculation on the part of address information. Each access point may be corresponding to one or more bits. When each access point is corresponding to multiple positions, multiple different hash algorithms may be used.

For example, H1( ) is a hash function 1, H2( ) is a hash function 2, SHA256( ) is a common hash function, and a length of the bit table is 128 bits. If each access point is corresponding to only one bit, the station may use SHA256 (address information of the access point) mod 128, that is, perform a modulo-128 operation on a value obtained by using the function SHA256( ) to calculate the address information of the access point, to obtain a position (bits 0 to 127) corresponding to the access point. If each access point is corresponding to two bits in the bit table, the station may use H1 (address information of the access point)=SHA256 (the address information of the access point+1) mod 128, and H2 (the address information of the access point)=SHA256 (the address information of the access point+2) mod 128 to determine different bit information of the two bits corresponding to the access point. The station may also use H1 (the address information of the access point)=truncate_1 (SHA256 (the address information of the access point)), and H2 (the address information of the access point)=truncate_2 (SHA256 (the address information of the access point)), where truncate_1( ) indicates that the first 7 bits (indicating 0-127) are truncated, and truncate_2( ) indicates that the second 7 bits are truncated, to determine the different bit information of the two bits corresponding to the access point.

It can be seen that in this embodiment, a station receives connection information sent by an access point, where the connection information includes a service node identity, so that the station can know which access points send connection information that includes a same service node identity, and therefore, the station may determine at least one query access point from these access points, and initiate a query request message to the at least one query access point to perform service query. In this way, at least one query access point sending query result information is determined on a station side, and not all possible access points need to reply with the query result information, which can avoid repeatedly sending query result information if multiple access points receive a query request message sent by a same station, thereby reducing data that is transmitted between the station and a service node by using the access points, and reducing transmission resources.

It should be noted that the service node identity included in the connection information herein may be a name of a service node, may also be a MAC address of a service node, and may further be a hash value obtained after hash calculation is performed on a name or a MAC address of a service node, or may be other identity information that can identify the service node.

When an access point is connected to one service node, the service node identity is identity information of the service node connected to the access point; when an access point is connected to multiple service nodes, the service node identity may be a list including multiple service node identities. In this way, when determining the at least one query access point, the station may select one or several access points from access points that send connection information including a service node identity corresponding to a same service node. Further, when determining the at least one query access point, the station may determine at least one different query access point for a different service node. For example, connection information sent by an access point 1 includes an identity of a service node A, connection information sent by an access point 2 includes identities of service nodes A and B, connection information sent by an access point 3 includes the identity of the service node B, and the station receives the connection information sent by the three access points. In this case, the station may select one or two access points from the access point 1 and the access point 2, as a query access point for the service node A; and select one or two access point from the access point 2 and the access point 3, as a query access point for the service node B.

### Method Embodiment 3 of the Present Invention

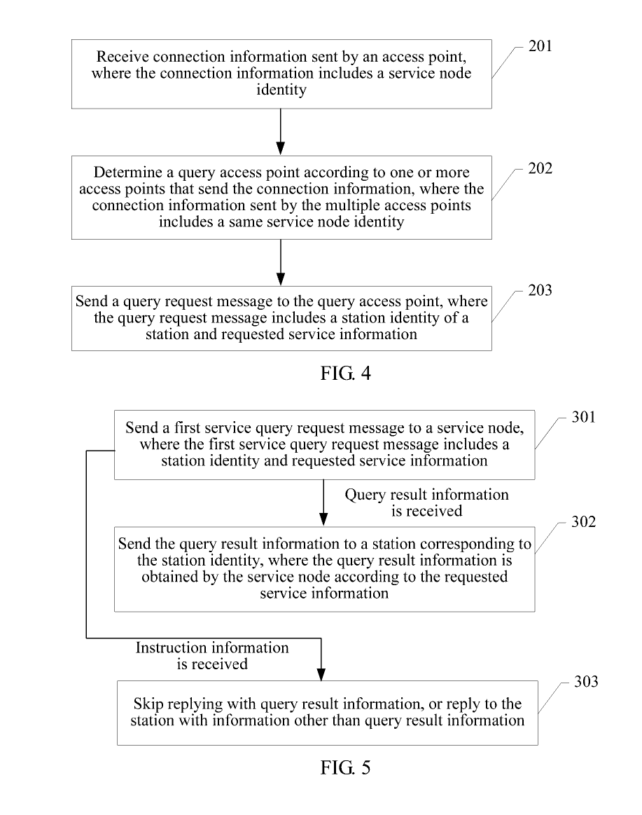

A service query method is provided, and may be mainly applied to the service query systems shown in the foregoing FIG. 1a and FIG. 1b. The method in this embodiment is a method executed by an access point in the system. A flowchart is shown in FIG. 5, and the method includes:

Step 301. Send a first service query request message to a service node, where the first service query request message includes a station identity and requested service information.

It may be understood that when needing to initiate a process for querying service information of a service node, a station may send a query request message to an access point, where the query request message may include a station identity and requested service information; and the access point may extract the station identity and the requested service information, and send the station identity and the requested service information to the service node by adding the station identity and the requested service information to a first service query request message, so that the service node may execute service query according to the method described in the foregoing Method Embodiment 1. Details are not described herein again.

When the access point receives query result information sent by the service node, step 302 is performed; if the access point receives instruction information sent by the service node, where the instruction information is used for instructing the access point not to send query result information, step 303 is performed.

Step 302. Send the query result information to a station corresponding to the station identity, where the query result information is obtained by the service node according to the requested service information in the first service query request message. Specifically, the access point may send the query result information to the station by adding the query result information to a query response message.

Step 303. Skip sending the query result information, or send information other than the query result information to the station. Specifically, the access point may send a query response message but not add the query result information to the query response message, or add some other information to the query response message for sending, for example, add information of each access point that sends the first service query request message to the service node. In this way, the station may know information of each access point connected to a same service node, and therefore may perform switching between these access points.

It should be noted that when the access point performs the foregoing step 301, the first service query request message may further include load indication information of the access point, and/or signal strength indication information of receiving a query request message of the station by the access point, so that the service node determines, according to the signal strength indication information and/or the load indication information, an access point that sends the query result information. Moreover, the first service query request message may further include a session identity, and in this case, the access point may receive the query result information and the session identity that are sent by the service node. When performing the foregoing step 302, the access point may send the query result information to the station in response to a query request message corresponding to the session identity; when performing the foregoing step 303, the access point may send other information than the query result information to the station in response to a query request message corresponding to the session identity.

It should be noted that the method executed by the access point in steps 301 to 303 in this embodiment may be the method executed by the access point corresponding to the service node in the foregoing Method Embodiment 1.

It can be seen that in this embodiment, when a station initiates a query request message and when the query request message reaches an access point, the access point extracts a station identity and requested service information from the query request message, and sends the station identity and the requested service information to a service node by adding the station identity and the requested service information to a first service query request message. When receiving query result information, the access point sends the query result information to the station; when receiving instruction information of not sending query result information, the access point does not send the query result information to the station. In this way, a service node determines whether an access point needs to reply with query result information, so that not all access points sending a first service query request message send the query result information, which can avoid repeatedly sending query result information if multiple access points receive a query request message sent by a same station, thereby reducing data that is transmitted between the station and the service node by using the access points, and reducing transmission resources.

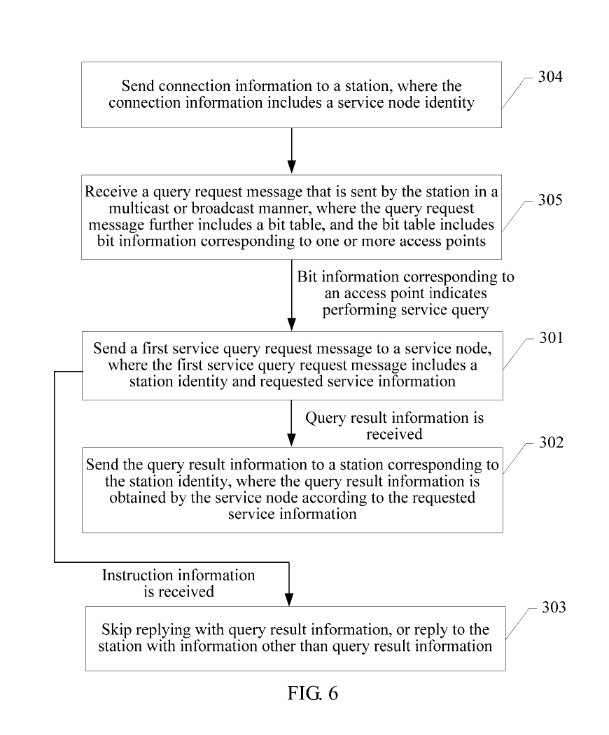

Referring to FIG. 6, in a specific embodiment, before performing the foregoing step 301, the access point may further perform the following steps 304 and 305, specifically:

Step 304. Send connection information to the station, where the connection information includes a service node identity. Specifically, the access point may actively send a beacon frame, where the beacon frame includes identity information of a service node connected to the access point; or when passively receiving a probe request frame sent by the station, the access point sends a probe response frame to the station, where the probe response frame includes identity information of a service node connected to the access point.

In this way, sending the connection information may enable the station to know the service node connected to the access point, so that the station determines at least one query access point from access points connected to a same service node, and sends a query request message to these query access points.

Step 305. Receive a query request message that is sent by the station in a multicast or broadcast manner, where the query request message further includes a bit table, and the bit table includes bit information corresponding to one or more access points. If bit information that is corresponding to the access point and in the bit table indicates performing service query, the foregoing step 301 is performed.

Bit information corresponding to an access point may be one or more bits, and may simply be 1 or 0; may be information that is obtained according to address information of the access point by using a hash algorithm; or the like.

In the step 305, if the access point receives a query request message that is sent by the station in a unicast manner, the foregoing step 301 is directly performed.

In addition, it should be noted that if the at least one query access point determined by the station has only one access point, because the station has considered a case in which multiple access points are connected to one service node, after one access point is selected to send the query request message, only the access point sends the first service query request message to the service node, and a case of repeatedly sending the query result information does not occur. In this case, the service node may directly send the query result information to the access point for sending. If the at least one query access point has multiple query access points, after these query access points send the first service query request message to the service node, the service node may perform service query according to the method described in the foregoing Method Embodiment 1. The service node may also select, from the multiple query access points, one or more first access points for sending the query result information.

It should be noted that the method executed by the access point in steps 304 and 305 to steps 301 to 303 in this embodiment may be the method executed by the access point corresponding to the service node in the foregoing Method Embodiment 2.

### Method Embodiment 4 of the Present Invention

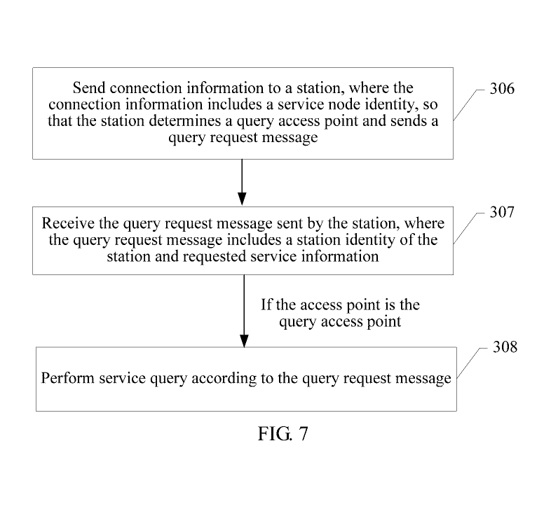

A service query method is provided, and may be mainly applied to the service query systems shown in the foregoing FIG. 1a and FIG. 1b. The method in this embodiment is a method executed by an access point in the system, and is the method executed by the access point in the foregoing Embodiment 2. A flowchart is shown in FIG. 7, and the method includes:

Step 306. Send connection information to a station, where the connection information includes a service node identity, and the service node identity may uniquely identify a service node. In this way, after the station receives the connection information, the station may determine and send a query request message according to the method described in the foregoing method Embodiment 2, and details are not described herein again.

Specifically, an access point may actively send a beacon frame, where the beacon frame includes identity information of a service node connected to the access point; or after receiving a probe request frame sent by the station, an access point passively sends a probe response frame to the station in response to the probe request frame, where the probe response frame includes identity information of a service node connected to the access point.

Step 307. Receive the query request message sent by the station, where the query request message includes a station identity of the station and requested service information, and may further include other information such as a session identity. If the access point in this embodiment is a query access point determined by the station, step 308 is performed. If the access point in this embodiment is not a query access point determined by the station, the access point does not perform service query, and the process ends.

Specifically, when the access point receives the query request message that is sent by the station in a unicast manner, step 308 is directly performed; when the access point receives the query request message that is sent by the station in a multicast or broadcast manner, where the query request message further includes a bit table, and if bit information that is corresponding to the access point and in the bit table indicates performing service query, step 308 is performed, where the bit table includes bit information corresponding to one or more access points, and the bit information that is corresponding to the access point and in the bit table may be information that is obtained by the station according to address information of the access point by using a hash algorithm.

Step 308. Perform service query according to the query request message received in step 307.

It may be understood that when the access point receives the query request message that is sent in the unicast manner, the requested service information in the query request message may be sent to the service node by adding the requested service information to a service query request message, to perform service query; if the access point receives the query request message that is sent in the broadcast or multicast manner, the service query method may be executed according to steps 301 to 303 in the foregoing Method Embodiment 2, and details are not described herein again.

It can be seen that in this embodiment, an access point sends connection information to a station, where the connection information includes a service node identity; the station determines at least one query access point according to the connection information, and sends a query request message; and when the query request message reaches an access point and if the node is a query access point, service query is performed according to the query request message. In this way, at least one query access point sending query result information is determined on a station side, and not all possible access points need to reply with the query result information, which can avoid repeatedly sending query result information if multiple access points receive a query request message sent by a same station, thereby reducing data that is transmitted between the station and a service node by using the access points, and reducing transmission resources.

The following Method Embodiment 5 and Method Embodiment 6 describe service query methods in the present invention by using specific application embodiments, where it is assumed that an access point 1, an access point 2, and an access point 3 are connected to a same service node; the access point 1 and the access point 2 work on a same wireless working channel, namely a channel 1; and the access point 3 works on another wireless working channel, namely a channel 2. Specifically:

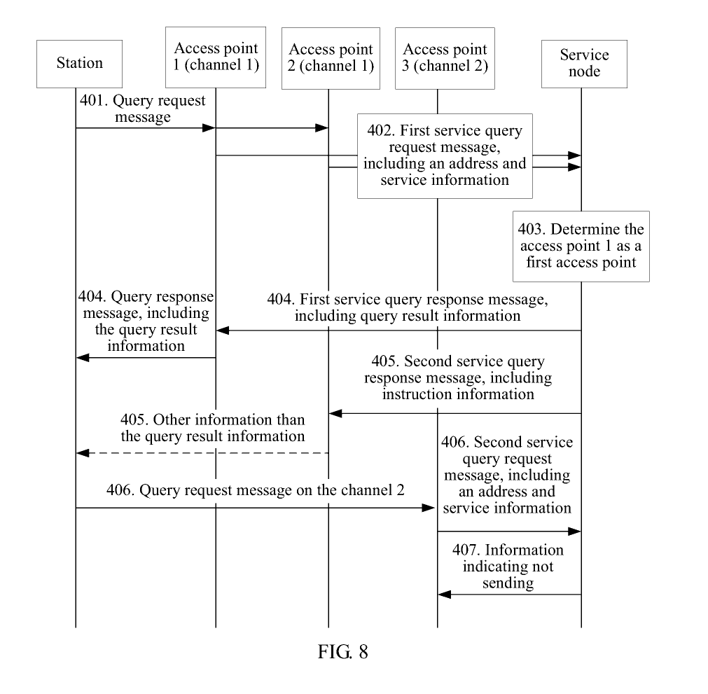

Referring to FIG. 8, the service query method described in Method Embodiment 5 of the present invention includes:

Step 401. A station performs search on the channel 1 and sends a query request message, where the query request message includes requested service information and a Media Access Control address (MAC) of the station, and may further include information such as a session identity (token ID). Herein, the requested service information may be a name of a requested service, for example, “printer”, or an ID of a requested service, for example, an ID number corresponding to “printer” or “Printer”, where the ID number may be appointed in a protocol or may be generated by using a certain method, for example, a hash value obtained by performing hash conversion on a service name. A hash method may be MD5, SHA256, SHA512, or the like. A length of the ID number may be 48 bits, or may be another value. The requested service information may be information of one service, or may be information of multiple services.

Step 402. After receiving the query request message, the access point 1 and the access point 2 execute a same method, that is, extract the MAC address of the station and the requested service information that are included in the query request message, and send the MAC address of the station and the requested service information to a service node by adding the MAC address of the station and the requested service information to a first service query request message, where the first service query request message may further carry information such as the session identity.

Step 403. After receiving one first service query request message and obtaining query result information, the service node may not first send the query result information to an access point that sends the first service query request message, but may store the first service query request message; collect statistics on first service query request messages that are received within a preset time; and determine one or more first access points in all access points that send these first service query request messages. In this embodiment, the access point 1 is determined as the first access point.

Step 404. The service node performs query according to the requested service information in the first service query request message to obtain the query result information, and sends a first service query response message to the access point 1, where the first service query response message includes the query result information and may further include the session identity. In this way, after receiving the first service query response message, the access point 1 sends, in response to the query request message (sent by the station in the step 401) corresponding to the session identity, the query result information to the station by adding the query result information to a query response message.

In this embodiment, the first service query request message may be stored, including the station identity and the requested service information, and/or the query result information may be stored, which is used by the station to initiate query to another access point on the current channel or another access point on another channel in a subsequent step.

Step 405. The service node sends a second service query response message to the access point 2, where the second service query response message includes instruction information that is used for instructing not to send the query result information, and may further include other information than the session identity and the query result information, such as information of each access point connected to the service node. In this way, after receiving the second service query response message, in response to the query request message corresponding to the session identity, the access point 2 sends other information than the query result information to the station by adding the other information to a query response message, or does not send a query response message.

A dashed line arrow in FIG. 8 indicates that this step is an optional step.

Step 406. The station initiates, on a channel 2, a query request message to an access point 3. After receiving the query request message, the access point 3 sends a MAC address of the station, requested service information, and the like that are carried in the query request message to the service node by adding the MAC address of the station, the requested service information, and the like to a second service query request message.

Step 407. After receiving the second service query request message, the service node knows that the station identity and the requested service information in the second service query request message are consistent with the station identity and the requested service information that are stored in the foregoing step 404, or knows that query result information of the second service query request message is consistent with the query result information stored in the foregoing step 404, which indicates that there is an access point that has queried the service information on another channel. Therefore, to avoid repeated work, the service node sends, to the access point 3, the instruction information of not sending the query result information.

In the foregoing embodiment, in a query request message that is sent by a station to an access point, and a first service query request message that is sent by an access point 1 to a service node, the station is identified by using a MAC address of the station. In another specific embodiment, a station may be identified according to information obtained after a MAC address is converted, for example, information obtained after hash calculation is performed on the MAC address. Moreover, in the foregoing embodiment, when the access point sends a service query request message to the service node, an RSSI may be carried to indicate strength information of receiving, by the access point, the query request message sent by the station, and load information of the access point may be also included. In this way, the service node knows actual information of each access point, and therefore may select an access point that has relatively light load and that has a relatively short route to the station as a first access point to send query result information.

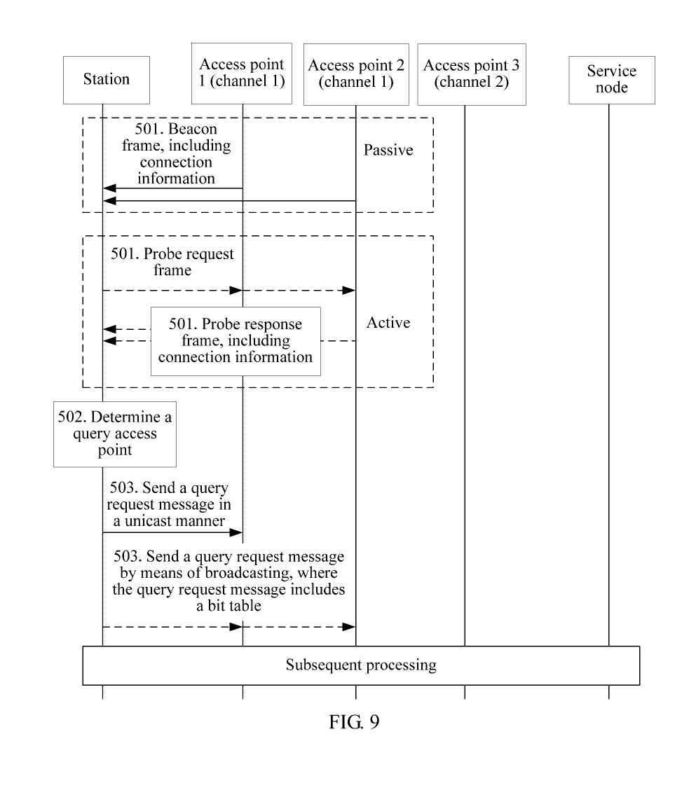

Referring to FIG. 9, the service query method described in Method Embodiment 6 of the present invention, where a dashed line arrow in FIG. 9 indicates an optional step, includes:

Step 501. A station may passively receive beacon frames sent by an access point 1 and an access point 2, where the beacon frames include identity information of a connected service node.

In another embodiment, the station may also actively send a probe request frame by means of broadcasting, and receive probe response frames returned by the access point 1 and the access point 2, where the probe response frames include the identity information of the connected service node.

Step 502. By using the foregoing step 501, the station may determine access points connected to a same service node, and determine a query access point from these access points. In this embodiment, there may be one or more determined query access points.

Step 503. The station sends a query request message to the query access point in a unicast manner; or the station may send a query request message by means of broadcasting, but need to add a bit table to the query request message, where bit information that is of the query access point and in the bit table is used to instruct the query access point to perform service query. The query request message includes a MAC address of the station, requested service information, and the like.

Subsequent processing after the step 503 may mainly include the following several methods:

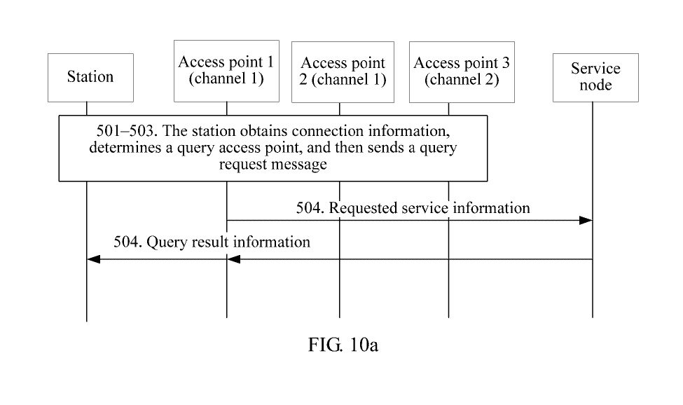

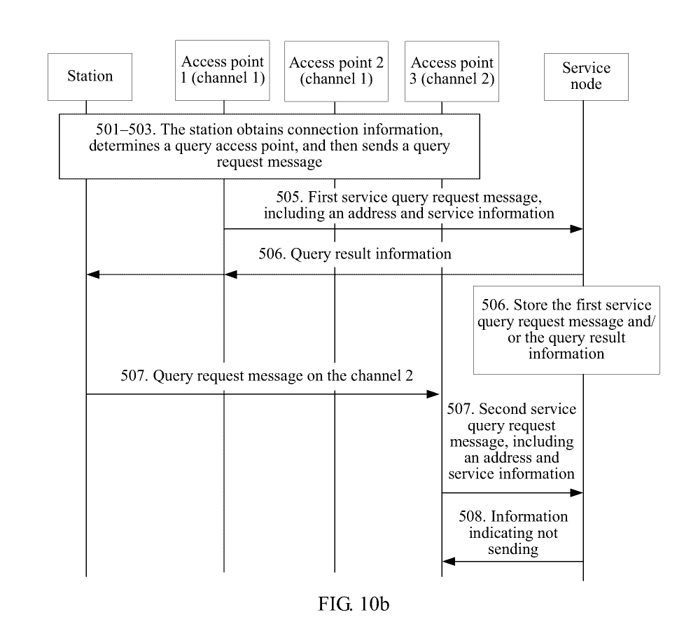

(1) Referring to FIG. 10a, when the station selects only one access point, namely the access point 1, as the query access point, after the station sends the query request message, the method in this embodiment further includes the following step 504. In this case, when sending the query request message, the station has considered a repeated operation resulting from that multiple access points are connected to a same service node. Specifically:

Step 504. After receiving the query request message that is sent in the unicast manner, the access point 1 may send only the requested service information in the query request message to the service node to perform service query, and may not send other information to the service node. After the access point 1 and the access point 2 receive the query request message that is sent by means of broadcasting, because only bit information of the access point 1 indicates performing service query, the access point 1 sends only the requested service information to the service node to perform service query. In this way, the service node directly sends query result information to the station by using the access point 1.

(2) Referring to FIG. 10b, when the station selects only one access point, namely the access point 1, as the query access point, after the station sends the query request message:

Step 505. The access point 1 sends the MAC address of the station, the requested service information, and the like in the query request message to the service node by adding the MAC address of the station, the requested service information, and the like to a first service query request message.

Step 506. The service node obtains query result information and sends the query result information to the station by using the access point 1. Meanwhile, the service node may further store the first service query request message, namely the station identity and the requested service information, and/or store the query result information, so as to facilitate an operation when the station subsequently initiates service query on another channel.

Step 507. The station initiates, on a channel 2, a query request message to an access point 3. After receiving the query request message, the access point 3 sends a MAC address of the station, requested service information, and the like that are carried in the query request message to the service node by adding the MAC address of the station, the requested service information, and the like to a second service query request message.

Step 508. After receiving the second service query request message, the service node knows that the station identity and the requested service information in the second service query request message are consistent with the station identity and the requested service information that are stored in the foregoing step 506, or knows that query result information of the second service query request message is consistent with the query result information stored in the foregoing step 506, which indicates that an access point has queried the service information on another channel. Therefore, to avoid repeated work, the service node sends, to the access point 3, instruction information of not sending the query result information.

(3) When the station selects more than two access points as query access points, when the station sends the query request message and after these query access points send a service query request message to the service node according to the query request message, service query may be performed according to the method described in steps 403 to 405 or steps 403 to 407 in the foregoing Method Embodiment 4, and details are not described herein again.

### Method Embodiment 7 of the Present Invention

According to the prior art, in a process of interaction between a station and an access point for performing service query, information of a service node is not represented. Therefore, after obtaining service query result information, the station does not know from which service node the service query result information comes. Then, when the station wants to continue to initiate query to another access point on a current channel or another channel, the another access point does not know either that the station has obtained query result information of which service nodes. Therefore, the another access point initiates service query to a service node connected to the another access point, and sends service query result information to the station. The service query result information may include query result information that has been obtained by the station, and therefore is repeatedly sent, thereby occupying wireless channel resources and decreasing a utilization rate of a wireless channel.

In this method embodiment of the present invention, a node identity of a service node is carried in a message carrying query result information, an acquired probe response frame, or a service query response message, so that a station knows from which service node service query result information comes. Then the station also adds identities of service nodes whose query result information has been acquired by the station and instruction information to a subsequent request message that is used for continuing to initiate query, so that an access point connected to these service nodes may not reply or simply reply according to the instruction information, thereby reducing wireless channel resource occupation and improving a utilization rate of a wireless channel.

A method provided in a method embodiment of the present invention is shown in FIG. 18. The method may include:

1801. A station obtains query result information of a first service node.

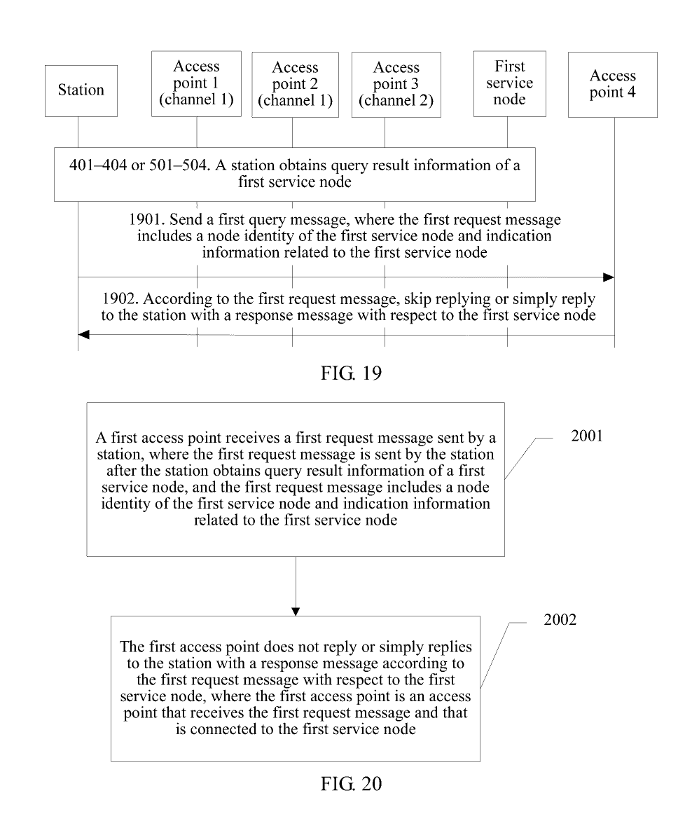

Specifically, a process for obtaining the query result information of the first service node by the station may be the process in the aforementioned steps 401 to 404 or steps 501 to 504, and reference may be made to FIG. 19.

1802. After obtaining the query result information of the first service node, the station sends a first request message, where the first request message includes a node identity of the first service node and indication information related to the first service node; and the indication information is used for indicating that the station has obtained the query result information of the first service node, and/or the indication information is used for indicating a manner in which a first access point replies to the first request message with respect to the first service node, so that the first access point replies with a response message according to the first request message, where the first access point is an access point that receives the first request message and that is connected to the first service node. Reference may be made to step 1901 in FIG. 19. The first access point may be an access point 4 shown in FIG. 19. A working channel of the first access point may not be limited. The first access point may be an access point connected to the first service node, except the access points 1, 2, or 3.

In a process for querying a service by the station, if the station has obtained service query result information of a service node, the station may add, during subsequent query, identity information of the service node and instruction information related to the service node to a first request message, to indicate to an access point receiving the query request and connected to the service node that the station has received the query result information of the service node and the access point should not reply or should simply reply.

The station may obtain the service query result information in multiple manners. The station may send a probe request frame, a service query request message, or another specially set action frame, where these frames or messages carry service information requested by the station, and receive a probe response frame, a service query response message, or another specially set action frame that is replied with by the access point. The probe request frame may be a probe request frame, the service query request message may be a GAS initial request message, the probe response frame may be a probe response frame, and the service query response message may be a GAS initial response message. The requested service information herein is service information that the station wants to discover, for example, “printer”, “scanner”, and “ATM auto teller machine”. The probe request frame, the service query request message, the dedicated request message, and the like herein are all referred to as a first request message.

That the station acquires the service query result information may be that when the station initiates query to the access point, the access point replies to the station with the query result information after immediately initiating query to the service node, or may be that the access point first acquires service information from the service node and buffers the service information, and then when the station initiates query to the access point, the access point sends, to the station, service information that is buffered by the access point and that matches the service information requested by the station.

By using the method in the present invention, after obtaining the service query result information, the station may know from which service node the service query result information comes. There are many possible cases, for example:

the query result information includes the node identity of the first service node; or

before obtaining the query result information of the first service node, the station receives a beacon frame sent by at least one access point, where the beacon frame includes the node identity of the first service node; or

before obtaining the query result information of the first service node, the station receives a first probe response frame that is sent by at least one access point in response to a first probe request frame, where the first probe response frame includes the node identity of the first service node; or

before obtaining the query result information of the first service node, the station receives a third service query response message that is sent by at least one access point in response to a third service query request message, where the service query response message includes the node identity of the first service node.

For example, in addition to carrying service query result information corresponding to requested service information, a received first probe response frame that is sent by an access point in response to a first probe request message, a received third service query response message that is sent by an access point in response to a third service query request message, or another received response message, such as a specially set action frame, that is sent by an access point in response to another request message further carries an identity of a service node that is queried by the access point for acquiring the service query result information. In this way, the station may know from which service node the query result information comes. For another example, before initiating query, the station receives a beacon frame, namely a beacon frame, of an access point, where the beacon frame carries an identity of a service node connected to the access point. When initiating query to the access point, the station knows from which service node query result information comes. Herein, the first probe request frame may be a probe request, the first probe response frame may be a probe response, the third service query request message may be a GAS initial request, the third service query response message may be a GAS initial response, and the specially set action frame may be some specially set frames that may be used for querying a service node, service information, or the like.

After a station obtains query result information from a service node, the station may further want to continue to query service information. For example, after a period of time, the station wants to know whether another service node also provides a service desired by the station on a channel; or the station obtains query result information on a channel, and further wants to know whether another service node also provides a service desired by the station on another channel. Therefore, the station may resend a first request message to perform query. However, because the station has obtained query result information of a service node, the station does not want to obtain the query result information of the service node again. As a result, the station may add an identity of the service node whose query result information has been obtained by the station and instruction information related to the service node to the first request message, so as to instruct an access point connected to the service node not to reply with a response or to only reply with a simple response, which can reduce response messages that are sent by the access point to the station, reduce wireless channel occupation, and improve a utilization rate of the wireless channel.

Multiple manners may be used to add identity information of the service node and the instruction information related to the service node to the first request message. One manner is: adding two information elements to the first request message, where one information element indicates the node identity of the service node, and one information element indicates the instruction information related to the service node, which is an explicit indication manner. Another manner is: adding one element to the first request message, where content carried in the element is the identity of the service node, a name or a feature of the element also indicates the indication information related to the service node, and the indication information may instruct the access point connected to the service node how to reply with a response, which is an implicit indication manner. These elements each may be added to a corresponding first request message in a form of an information element, regardless of the manner.

The indication information that is added by the station to the first request message and that is related to the service node may notify the access point connected to the service node that the station has acquired the query result information of the service node, and instruct the access point to make no reply or make a simple reply. The simple reply refers to replying with a simple response message, with a purpose of enabling the station to know that the access point is also connected to the service node. In this way, when the station subsequently selects an associated access point, one more access point may be selected. For example, the station discovers that a signal of the access point is relatively strong, and therefore selects the access point for association, and the like. The response message returned as the simple reply may be a response message corresponding to the first request message sent by the station. For example, when the first request message is a probe request, the response message returned as the simple reply is a probe response; when the first request message is a GAS initial request message, the response message returned as the simple reply is a GAS initial response message. Certainly, the response message returned as the simple reply may also be another frame or message, which is not limited herein. These responded frames or messages do not carry the query result information of the service node, but are only used to notify the station of existence of the access point. The notifying the station of existence of the access point connected to the service node may be represented by adding the node identity of the service node; and may also be indicated by adding a special information element, for example, the information element indicates a first request message and that the access point is connected to a service node included in the first request message, or the like.

In another case, the access point receiving the first request message is also connected to another service node in addition to being connected to the service node corresponding to the node identity carried in the message. Therefore, the access point may initiate service query to the another service node. Then in a query response message as a reply to the station, for the service node corresponding to the node identity carried in the first request message, there is no response content, or there is only simple response content for indicating existence of the access point.

The first request message that is sent by the station in subsequent query and that carries the identity information of the service node may be a probe request message, namely a probe request message, where the probe request message carries the identity information of the service node; may be a service query request message, namely a GAS initial request message, where the service query request message carries the identity information of the service node; may be another request message, for example, a specially set action frame, where the another request message carries the identity information of the service node; or the like.

For an access point, as shown in FIG. 20, a service query method provided in an embodiment of the present invention includes:

2001. A first access point receives a first request message sent by a station, where the first request message is sent by the station after the station obtains query result information of a first service node; the first request message includes a node identity of the first service node and indication information related to the first service node; and the indication information is used for indicating that the station has obtained the query result information of the first service node, and/or the indication information is used for indicating a manner in which the first access point replies to the first request message with respect to the first service node.

2002. The first access point replies with a response message according to the first request message, where the first access point is an access point that receives the first request message and that is connected to the first service node.

Specifically, the first access point may not reply or simply reply to the station with the response message according to the indication information in the first request message with respect to the first service node, as shown in step 1902 in FIG. 19.

### Method Embodiment 8 of the Present Invention

According to the prior art, in a process of interaction between a station and an access point for performing service query, information of a service node is not represented. Therefore, after obtaining service query result information, the station does not know from which service node the service query result information comes. Then, when the station wants to continue to initiate query to another access point on a current channel or another channel, if the station does not first determine whether a service node connected to the another access point is the service node whose query result information has been obtained by the station, an access point that receives a request message sent by the station may just be connected to the service node whose query result information has been obtained by the station. In this way, the access point initiates query to the service node and repeatedly sends same query result information to the station, and therefore, the query result information is repeatedly sent, thereby occupying wireless channel resources and decreasing a utilization rate of a wireless channel.

In this method embodiment of the present invention, a node identity of a service node is carried in a message carrying query result information, an acquired probe response frame, or a service query response message, so that a station knows from which service node service query result information comes. Then, in a subsequent process for preparing to continue to initiate query, the station first detects whether a surrounding access point is connected to a service node whose query result information has been acquired by the station; and if yes, does not need to initiate query to the access point, which reduces wireless channel resource occupation and improves a utilization rate of a wireless channel.

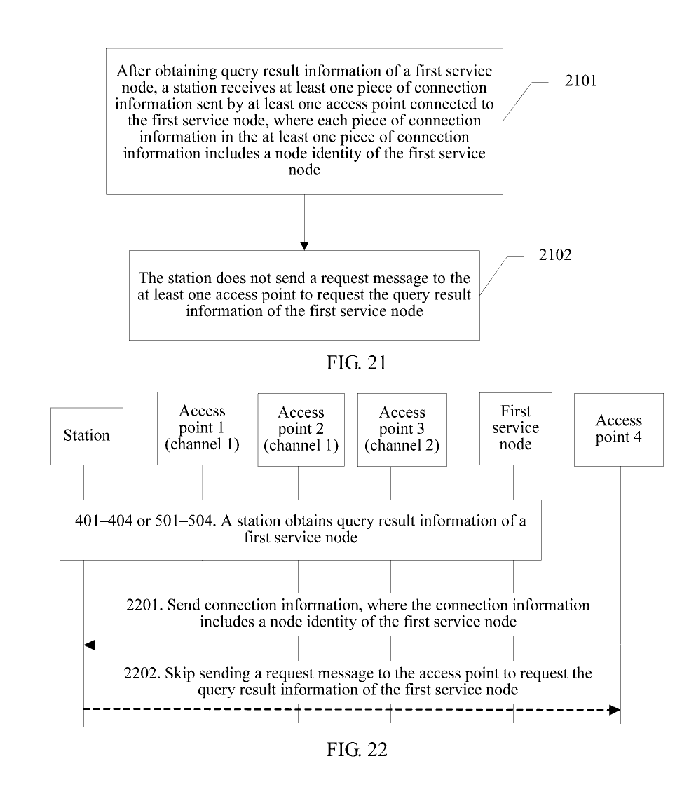

A method provided in a method embodiment of the present invention is shown in FIG. 21. The method may include:

2101. After obtaining query result information of a first service node, a station receives at least one piece of connection information sent by at least one access point connected to the first service node, where each piece of connection information in the at least one piece of connection information includes a node identity of the first service node.

Specifically, a process for obtaining the query result information of the first service node by the station may be the process in the aforementioned steps 401 to 404 or steps 501 to 504, and reference may be made to FIG. 22.

The at least one access point may include an access point 4 shown in FIG. 22. A working channel of the at least one access point may not be limited. The at least one access point may be an access point connected to the first service node, except the access points 1, 2, and 3.

As shown in FIG. 22, step 2201 is: after obtaining the query result information of the first service node, the station receives connection information sent by the access point 4, where the connection information includes the node identity of the first service node.

2102. The station does not send a request message to the at least one access point to request the query result information of the first service node. Reference may be made to step 2202 in FIG. 22.

The method is specifically: in a process for querying a service by the station, if the station has obtained service query result information of a service node, during subsequent query, if the station knows, by receiving connection information sent by an access point, that a service node connected to the access point is just the service node whose query result information has been obtained by the station, the station may not initiate query to the access point.

The station may obtain the service query result information in multiple manners. The station may send a probe request frame, a service query request message, or another specially set action frame, where these frames or messages carry service information requested by the station, and receive a probe response frame, a service query response message, or another specially set action frame that is replied with by the access point. The probe request frame may be a probe request frame, the service query request message may be a GAS initial request message, the probe response frame may be a probe response frame, and the service query response message may be a GAS initial response message. The requested service information herein is service information that the station wants to discover, for example, “printer”, “scanner”, and “ATM auto teller machine”. The probe request frame, the service query request message, the dedicated request message, and the like herein may be all referred to as a request message, and may be specifically selected according to a need.

By using the method in the present invention, after obtaining the service query result information, the station may know from which service node the service query result information comes. There are many possible cases, for example:

the query result information includes the node identity of the first service node; or

before obtaining the query result information of the first service node, the station receives a third probe response frame that is sent by at least one access point in response to a third probe request frame, where the third probe response frame includes the node identity of the first service node; or

before obtaining the query result information of the first service node, the station receives a fifth service query response message that is sent by at least one access point in response to a fifth service query request message, where the fifth service query response message includes the node identity of the first service node.

Specifically, for example, in addition to carrying service query result information corresponding to requested service information, a received third probe response frame that is sent by an access point in response to a third probe request frame, or a received fifth service query response message that is sent by an access point in response to a fifth service query request message, or another received response message, such as a specially set action frame, that is sent by an access point in response to another request message further carries an identity of a service node that is queried by the access point for acquiring the service query result information. In this way, the station may know from which service node the query result information comes. For another example, before initiating query, the station receives a beacon frame of an access point, where the beacon frame carries a node identity of a service node connected to the access point. When initiating query to the access point, the station knows from which service node query result information comes. Herein, the third probe request frame may be a probe request, the third probe response frame may be a probe response, the fifth service query request message may be a GAS initial request, the fifth service query response message may be a GAS initial response, and the specially set action frame may be some specially set frames that may be used for querying a service node, service information, or the like.

During subsequent query, there are also many manners used by the station to know, by receiving connection information sent by an access point, that a service node connected to the access point is just the service node whose query result information has been obtained by the station, for example:

receiving, by the station, a beacon frame sent by the at least one access point, where the beacon frame includes the connection information; or

receiving, by the station, a fourth probe response frame that is sent by the at least one access point in response to a fourth probe request frame, where the fourth probe response frame includes the connection information; or

receiving, by the station, a sixth service query response message that is sent by the at least one access point in response to a sixth service query request message, where the sixth service query response message includes the connection information.

Specifically, one manner is: listening to, by the station, a beacon frame, namely a beacon frame, sent by an access point, where the beacon frame carries a node identity of a service node connected to the access point, and if the node identity of the service node is the same as a node identity of the service node whose query result information has been obtained by the station, knowing that the service node connected to the access point is just the service node whose query result information has been obtained by the station; one manner is: sending a fourth probe request frame, and during network discovery, receiving a fourth probe response frame replied with by an access point, where the fourth probe response frame carries a node identity of a service node connected to the access point, thereby knowing that the service node connected to the access point is just the service node whose query result information has been obtained by the station; one manner is: receiving a sixth service query response message that is sent by an access point in response to a sixth service query request message, where the sixth service query response message carries a node identity of a service node connected to the access point, thereby knowing that the service node connected to the access point is just the service node whose query result information has obtained by the station; another manner may further be: obtaining a node identity of a service node connected to an access point by using a specially defined action frame; and the like. Herein, the fourth probe request frame may be a probe request, the fourth probe response frame may be a probe response, the sixth service query request message may be a GAS initial request, and the sixth service query response message may be a GAS initial response. Herein, the fourth probe request frame and the sixth service query request message may be sent by the station, or may be sent by another station.

That the station does not initiate query to the access point may mean that the station does not send a probe request message carrying requested service information, namely a probe request, to the access point, does not send a service query request message carrying requested service information, namely a GAS initial request, to the access point, does not send another action frame carrying requested service information to the access point, or the like. All these messages are messages that can carry a node identity of a service node.

Further, if the station obtains multiple node identities of service nodes connected to the access point, and if the node identity of the service node whose query result information has been obtained by the station is one of the multiple node identities, if the station only wants to acquire service query result information of the service node whose query result information has been acquired, the station does not initiate query to the access point.

A channel on which the station obtains query result information of a service node may be different from a channel on which the station knows, during subsequent query, that a service node connected to an access point is just the service node whose query result information has been obtained by the station.

### Device Embodiment 1 of the Present Invention

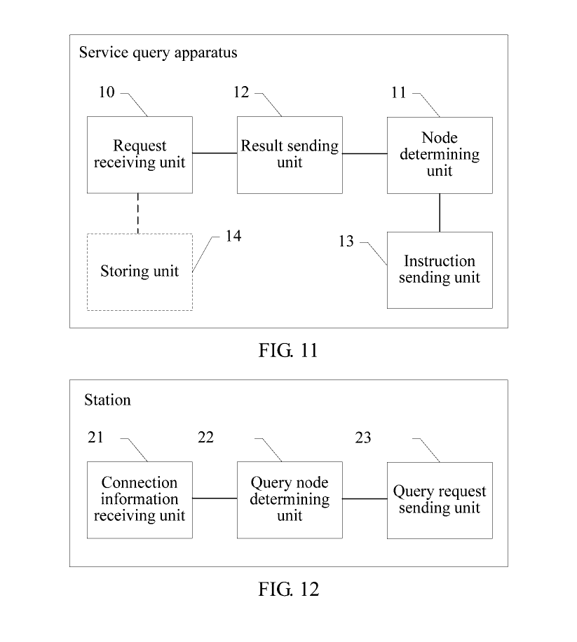

A service query apparatus, namely the foregoing service node, is provided. A schematic structural diagram may be shown in FIG. 11, where units in this embodiment may perform service query according to the method described in the foregoing Method Embodiment 1. The service query apparatus includes:

a request receiving unit 10, configured to receive a first service query request message sent by at least one access point, where the first service query request message includes a station identity and requested service information;

a node determining unit 11, configured to determine a first access point according to the at least one access point;

a result sending unit 12, configured to send query result information to the first access point determined by the node determining unit 11, so that the first access point sends the query result information to a station corresponding to the station identity, where the query result information is obtained by the service query apparatus according to the requested service information in the first service query request message received by the request receiving unit 10, where the result sending unit 12 is specifically configured to send a first service query response message to the first access point, where the first service query response message includes the query result information, so that the first access point sends the query result information to the station according to the first service query response message; and

an instruction sending unit 13, configured to: if the at least one access point includes multiple access points, send instruction information to another access point than the first access point determined by the node determining unit 11 in the at least one access point, where the instruction information is used for instructing the another access point not to send the query result information, where the instruction sending unit 13 is specifically configured to send a second service query response message to the another access point, where the second service query response message includes the instruction information, and the instruction information is used for instructing the another access point not to send the query result information, so that the another access point does not send the query result information according to the second service query response message.

In the service query apparatus in this embodiment, when a request receiving unit 10 receives first service query request messages sent by multiple access points, where the first service query request message includes a station identity and requested service information, a result sending unit 12 sends query result information to only one or more access points, namely, a first access point, determined by a node determining unit 11 in the multiple access points, so as to send the query result information to a station corresponding to the station identity, and an instruction sending unit 13 sends instruction information to another access point to instruct the another access point not to send the query result information. In this way, after receiving service query request messages that are from a same station and used for requesting same service information, the service query apparatus does not repeatedly send query result information to all access points to reply to the station, but selects one or more access points to reply to the station with the query result information, thereby reducing data that is transmitted between the station and the service query apparatus by using the access points, and reducing transmission resources.

In a specific embodiment, if the first service query request message received by the request receiving unit 10 further includes: load indication information of the access point, and/or signal strength indication information of receiving a query request message by the access point, the node determining unit 11 is specifically configured to determine the first access point according to the signal strength indication information and/or the load indication information that is included in the first service query request message received by the request receiving unit 10. If the first service query request message received by the request receiving unit 10 further includes a session identity, the result sending unit 12 is specifically configured to send the session identity in the first service query request message received by the request receiving unit 10 and the query result information to the first access point, so that the first access point sends the query result information to the station in response to a query request message corresponding to the session identity, where the query request message is sent by the station and received by the first access point.

Moreover, in another specific embodiment, the service query apparatus may further include: a storing unit 14 (in FIG. 11, a dashed line part is used to indicate that the storing unit 14 is an optional unit), configured to store the first service query request message and/or the query result information. In this case, when the request receiving unit 10 receives a second service query request message sent by the station by using a second access point, and if requested service information in the second service query request message received by the request receiving unit 10 is consistent with the requested service information in the first service query request message stored by the storing unit 14, or if query result information of the second service query request message is consistent with the stored query result information, the instruction sending unit 13 sends the instruction information to the second access point, where the instruction information is used for instructing the second access point not to send the query result information to the station, thereby further avoiding a repeated operation.

### Device Embodiment 2 of the Present Invention

A station is provided. A schematic structural diagram is shown in FIG. 12, where units in this embodiment may perform service query according to the method described in the foregoing Method Embodiment 2. The station includes:

a connection information receiving unit 21, configured to receive connection information sent by an access point, where the connection information includes a service node identity, and the connection information receiving unit 21 is specifically configured to receive a beacon frame sent by the access point, where the beacon frame includes identity information of a service node connected to the access point, or is specifically configured to receive a probe response frame that is sent by the access point in response to a probe request frame, where the probe response frame includes identity information of a service node connected to the access point;

a query node determining unit 22, configured to determine one or more query access points according to one or more access points that send the connection information, where the connection information sent by the multiple access points includes a same service node identity; and

a query request sending unit 23, configured to send a query request message to the at least one query access point determined by the query node determining unit 22, where the query request message includes a station identity of the station and requested service information, so that the at least one query access point performs service query according to the query request message.

The query request sending unit 23 is specifically configured to send the query request message to the at least one query access point in a unicast manner, so that the at least one query access point sends query result information to the station; or is specifically configured to send the query request message in a multicast or broadcast manner, where the query request message further includes a bit table, and use bit information that is corresponding to the at least one query access point and in the bit table to indicate sending query result information, where the bit table includes bit information corresponding to one or more access points. The bit information that is corresponding to the at least one query access point and in the bit table is information that is obtained according to address information of the at least one query access point by using a hash algorithm, or may be information indicated by one or more 0s or 1s.

In the station in this embodiment, a connection information receiving unit 21 receives connection information sent by an access point, and then may know, according to the connection information, which access points send connection information that includes a same service node identity; a query node determining unit 22 determines at least one query access point from these access points; and finally, a query request sending unit 23 initiates a query request message to the at least one query access point to perform service query. In this way, at least one query access point sending query result information is determined on a station side, and not all possible access points need to send the query result information, which can avoid repeatedly sending query result information if multiple access points receive a query request message sent by a same station, thereby reducing data that is transmitted between the station and a service node by using the access points, and reducing transmission resources.

### Device Embodiment 3 of the Present Invention

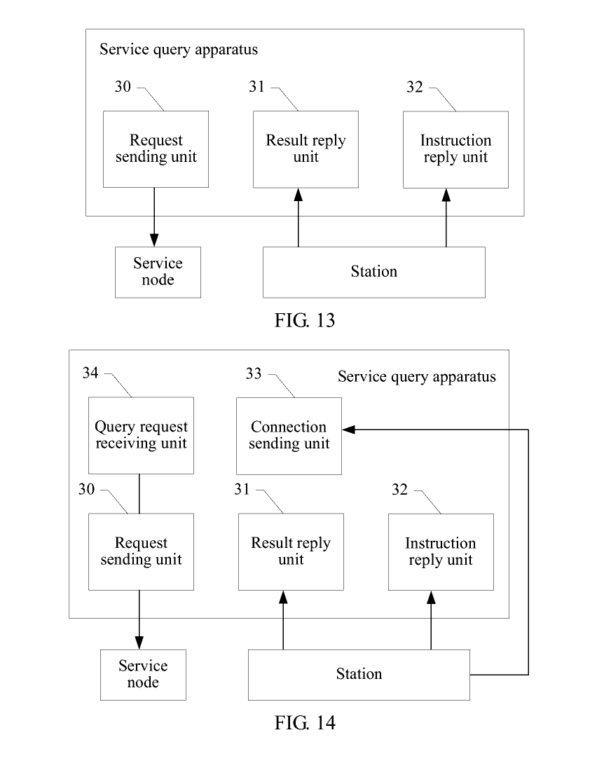

A service query apparatus, namely the foregoing access point, is provided. A schematic structural diagram is shown in FIG. 13, where a service node and a station shown in FIG. 13 are drawn to help describe the service query apparatus in this embodiment, and units in this embodiment may perform service query according to the method described in the foregoing Method Embodiment 3. The service query apparatus includes:

a request sending unit 30, configured to send a first service query request message to a service node, where the first service query request message includes a station identity and requested service information;

a result reply unit 31, configured to: when query result information sent by the service node is received, send the query result information to a station corresponding to the station identity, where the query result information is obtained by the service node according to the requested service information in the first service query request message sent by the request sending unit; and

an instruction reply unit 32, configured to: if instruction information sent by the service node is received, where the instruction information is used for instructing the service query apparatus not to send the query result information, skip sending the query result information, or send information other than the query result information to the station.

In a specific embodiment, the first service query request message sent by the request sending unit 30 further includes: load indication information of the service query apparatus, and/or signal strength indication information of receiving a query request message by the service query apparatus, so that the service node determines, according to the signal strength indication information and/or the load indication information, an access point that sends the query result information; and/or the first service query request message sent by the request sending unit 30 further includes a session identity, and in this case, the result reply unit 31 in the service query apparatus is specifically configured to: when the query result information and the session identity that are sent by the service node are received, send the query result information to the station in response to a query request message corresponding to the session identity.

It can be seen that when a station initiates a query request message and when the query request message reaches the service query apparatus in this embodiment, a request sending unit 30 extracts a station identity and requested service information from the query request message, and sends the station identity and the requested service information to a service node by adding the station identity and the requested service information to a first service query request message. When receiving query result information, a result reply unit 31 sends the query result information to the station. When receiving instruction information of not sending query result information, an instruction reply unit 32 does not send the query result information to the station. In this way, a service node determines whether the service query apparatus needs to reply with query result information, so that not all service query apparatuses sending a first service query request message send query result information, which can avoid repeatedly sending query result information if multiple service query apparatuses receive a query request message sent by a same station, thereby reducing data that is transmitted between the station and the service node by using the service query apparatuses, and reducing transmission resources.

Referring to FIG. 14, in a specific embodiment, in addition to including the structure shown in FIG. 13, the service query apparatus may further include a connection sending unit 33 and a query request receiving unit 34.

The connection sending unit 33 is configured to send connection information to the station, where the connection information includes a service node identity. Specifically, the connection sending unit 34 is specifically configured to send a beacon frame, where the beacon frame includes identity information of a service node connected to the service query apparatus; or is specifically configured to: when a probe request frame sent by the station is received, send a probe response frame to the station, where the probe response frame includes identity information of a service node connected to the service query apparatus.

The query request receiving unit 34 is configured to receive the query request message that is sent by the station in a multicast or broadcast manner, where the query request message further includes a bit table, the bit table includes bit information corresponding to one or more access points, and bit information that is corresponding to the service query apparatus and in the bit table is information that is obtained by the station according to address information of the service query apparatus by using a hash algorithm. The query request receiving unit 35 is further configured to receive the query request message that is sent by the station in a unicast manner.

In this embodiment, after the connection sending unit 33 sends the connection information, if the query request receiving unit 34 receives the query request message, and if the bit information that is corresponding to the service query apparatus and in the bit table included in the query request message indicates performing service query, the request sending unit 30 performs the step of sending a first service query request message to a service node. If the query request receiving unit 34 receives the query request message that is sent in the unicast manner, the request sending unit 30 may be directly triggered to perform the step of sending a first service query request message to a service node.

### Embodiment 4 of the Present Invention

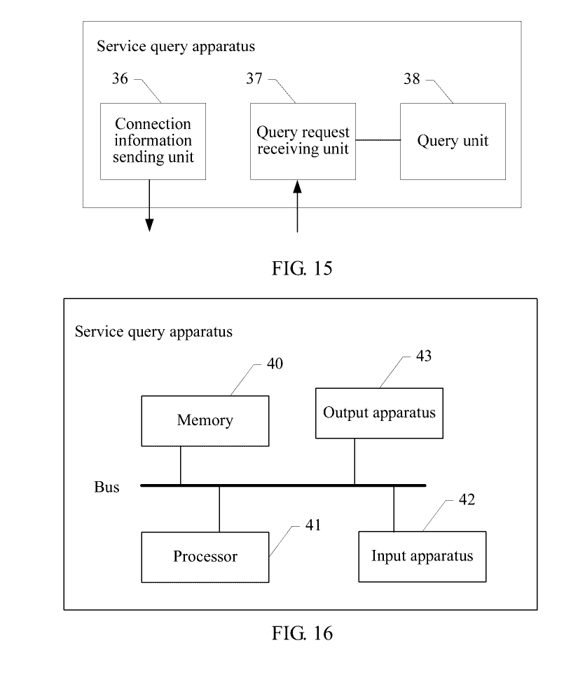

A service query apparatus, namely the foregoing access point, is further provided. A schematic structural diagram may be shown in FIG. 15, where units in this embodiment may perform service query according to the method described in the foregoing Method Embodiment 4. The service query apparatus includes: a connection information sending unit 36, a query request receiving unit 37, and a query unit 38.

The connection information sending unit 36 is configured to send connection information to a station, where the connection information includes a service node identity, so that the station determines at least one query access point according to one or more access points that send the connection information, and sends a query request message, where the connection information sent by the multiple access points includes a same service node identity.

The connection information sending unit 36 is specifically configured to send a beacon frame, where the beacon frame includes identity information of a service node connected to the service query apparatus; or the connection information sending unit 36 is specifically configured to: when a probe request frame sent by the station is received, send a probe response frame to the station in response to the probe request frame, where the probe response frame includes identity information of a service node connected to the service query apparatus.

The query request receiving unit 37 is configured to receive the query request message sent by the station, where the query request message includes a station identity of the station and requested service information.

The query request receiving unit 37 is specifically configured to receive the query request message that is sent by the station in a unicast manner, and instruct the query unit to perform the step of performing service query according to the query request message; or the query request receiving unit 37 is specifically configured to receive the query request message that is sent by the station in a multicast or broadcast manner, where the query request message further includes a bit table, and if bit information that is corresponding to the service query apparatus and in the bit table indicates performing service query, instruct the query unit to perform the step of performing service query according to the query request message, where the bit table includes bit information corresponding to one or more access points. The bit information that is corresponding to the service query apparatus and in the bit table is information that is obtained by the station according to address information of the service query apparatus by using a hash algorithm.

The query unit 38 is configured to: if the service query apparatus is the query access point determined by the station, perform service query according to the query request message received by the query request receiving unit 37. If the service query apparatus is not the query access point determined by the station, the query unit does not execute a service query operation.

It may be understood that when the query request receiving unit 37 receives the query request message that is sent in the unicast manner, the query unit 38 may send the requested service information in the query request message to the service node by adding the requested service information to a service query request message, to perform service query. If the query request receiving unit 37 receives the query request message that is sent in the broadcast or multicast manner, the query unit 38 may execute the service query method according to steps 301 to 303 in the foregoing Method Embodiment 2, and details are not described herein again.

It can be seen that in this embodiment, a connection information sending unit 36 of the service query apparatus sends connection information to a station, where the connection information includes a service node identity, so that the station determines at least one query access point according to the connection information and sends a query request message; and when the query request message reaches a query request receiving unit 37 of the service query apparatus, if the service query apparatus is the query access point, a query unit 38 performs service query according to the query request message. In this way, at least one query access point sending query result information is determined on a station side, and not all possible access points need to reply with the query result information, which can avoid repeatedly sending query result information if multiple access points receive a query request message sent by a same station, thereby reducing data that is transmitted between the station and a service node by using the access points, and reducing transmission resources.

### Device Embodiment 5 of the Present Invention

A service query apparatus, namely the foregoing service node, is provided. A schematic structural diagram is shown in FIG. 16, where units in this embodiment may perform service query according to the method described in the foregoing Method Embodiment 1. The service query apparatus includes a memory 40, a processor 41, an input apparatus 42, and an output apparatus 43 that are separately connected to a bus.

The memory 40 is configured to store data input from the input apparatus 42, and may further store information such as a file necessary for the processor 41 to process data. The input apparatus 42 and the output apparatus 43 are ports of the service query apparatus for communicating with another device.

The processor 41 is configured to: when the input apparatus 42 receives a first service query request message sent by at least one access point, where the first service query request message includes a station identity and requested service information, determine a first access point according to the at least one access point; control the output apparatus 43 to send query result information to the first access point, so that the first access point sends the query result information to a station corresponding to the station identity, where the query result information is obtained by the processor 41 according to the requested service information in the first service query request message received by the input apparatus 42; and if the at least one access point includes multiple access points, control the output apparatus 43 to send instruction information to another access point than the first access point in the at least one access point, where the instruction information is used for instructing the another access point not to send the query result information. In this way, after receiving service query request messages that are from a same station and used for requesting same service information, the service query apparatus does not repeatedly send query result information to all access points to reply to the station, but selects one or more access points to reply to the station with the query result information, thereby reducing data that is transmitted between the station and the service query apparatus by using the access points, and reducing transmission resources.

When controlling the output apparatus 43 to send the query result information, the processor 41 is specifically configured to send a first service query response message to the first access point, where the first service query response message includes the query result information, so that the first access point sends the query result information to the station according to the first service query response message. When controlling the output apparatus 43 to send the instruction information, the processor 41 is specifically configured to send a second service query response message to the another access point, where the second service query response message includes the instruction information, and the instruction information is used for instructing the another access point not to send the query result information, so that the another access point does not send the query result information according to the second service query response message.

In a specific embodiment, if the first service query request message received by the input apparatus 42 further includes: load indication information of the access point, and/or signal strength indication information of receiving a query request message by the access point, when determining the first access point, the processor 41 is specifically configured to determine the first access point according to the signal strength indication information and/or the load indication information that is included in the first service query request message. If the first service query request message received by the input apparatus 42 further includes a session identity, the processor 41 is specifically configured to control the output apparatus 43 to send the session identity in the received first service query request message and the query result information to the first access point, so that the first access point sends the query result information to the station in response to a query request message corresponding to the session identity, where the query request message is sent by the station and received by the first access point.

Moreover, in another specific embodiment, the memory 40 of the service query apparatus may be further configured to store the first service query request message and/or the query result information. In this case, when the input apparatus 42 receives a second service query request message that is sent by the station by using a second access point, if requested service information in the second service query request message is consistent with the requested service information in the first service query request message stored by the memory 40, or if query result information of the second service query request message is consistent with the stored query result information, the processor 41 controls the output apparatus 43 to send the instruction information to the second access point, where the instruction information is used for instructing the second access point not to send the query result information to the station, thereby further avoiding a repeated operation.

### Device Embodiment 6 of the Present Invention

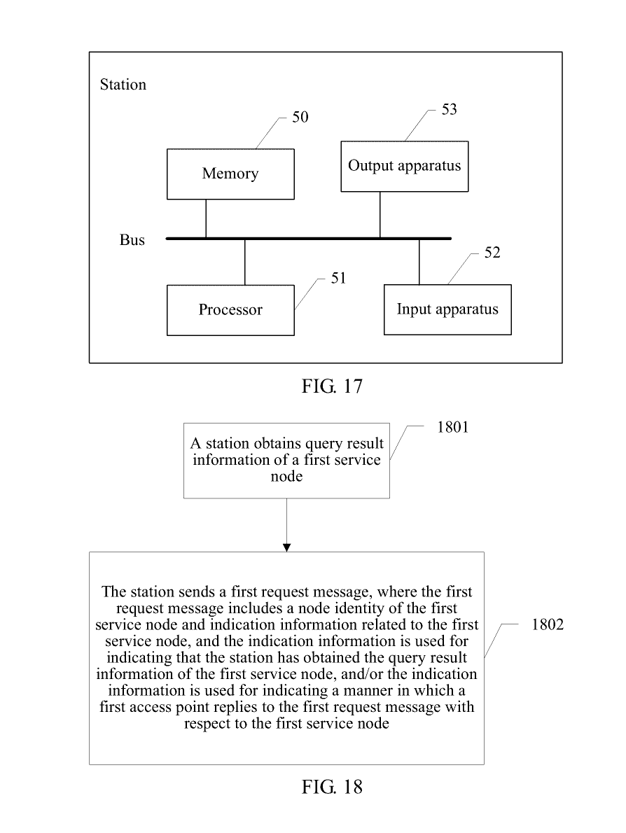

A station is provided. A schematic structural diagram is shown in FIG. 17, where units in this embodiment may perform service query according to the method described in the foregoing Method Embodiment 2. The station includes: a memory 50, a processor 51, an input apparatus 52, and an output apparatus 53 that are separately connected to a bus.

The memory 50 is configured to store data input from the input apparatus 52, and may further store information such as a file necessary for the processor 51 to process data. The input apparatus 52 and the output apparatus 53 are ports of the station for communicating with another device.

The processor 51 is configured to: when the input apparatus 52 receives connection information sent by an access point, where the connection information includes a service node identity, determine a query access point according to one or more access points that send the connection information, where the connection information sent by the multiple access points includes a same service node identity; and control the output apparatus 53 to send a query request message to at least one query access point, where the query request message includes a station identity of the station and requested service information, so that the at least one query access point performs service query according to the query request message. In this way, at least one query access point sending query result information is determined on a station side, and not all possible access points need to send the query result information, which can avoid repeatedly sending query result information if multiple access points receive a query request message sent by a same station, thereby reducing data that is transmitted between the station and a service node by using the access points, and reducing transmission resources.

When receiving the connection information, the input apparatus 52 is specifically configured to receive a beacon frame sent by the access point, where the beacon frame includes identity information of a service node connected to the access point; or is specifically configured to receive a probe response frame that is sent by the access point in response to a probe request frame, where the probe response frame includes identity information of a service node connected to the access point. Moreover, when controlling the output apparatus 53 to send the query request message, the processor 51 is specifically configured to send the query request message to the at least one query access point in a unicast manner, so that the at least one query access point sends query result information to the station; or is specifically configured to send the query request message in a multicast or broadcast manner, where the query request message further includes a bit table, and use bit information that is corresponding to the at least one query access point and in the bit table to indicate sending query result information, where the bit table includes bit information corresponding to one or more access points. The bit information that is corresponding to the at least one query access point and in the bit table is information that is obtained by the station according to address information of the at least one query access point by using a hash algorithm.

### Device Embodiment 7 of the Present Invention

A service query apparatus, namely the foregoing access point, is provided. A structure of the service query apparatus is similar to the structure of the service query apparatus shown in the foregoing FIG. 16, where units in this embodiment may perform service query according to the method described in the foregoing Method Embodiment 3. The service query apparatus includes: a memory, a processor, an input apparatus, and an output apparatus that are separately connected to a bus.

The memory is configured to store data input from the input apparatus, and may further store information such as a file necessary for the processor to process data. The input apparatus and the output apparatus are ports of the service query apparatus for communicating with another device.

The processor is configured to control the output apparatus to send a first service query request message to a service node, where the first service query request message includes a station identity and requested service information; and when the input apparatus receives query result information sent by the service node, control the output apparatus to send the query result information to a station corresponding to the station identity, where the query result information is obtained by the service node according to the requested service information in the first service query request message sent by the request sending unit; or if the input apparatus receives instruction information sent by the service node, where the instruction information is used for instructing the service query apparatus not to send query result information, skip sending the query result information, or control the output apparatus to send information other than the query result information to the station. In this way, a service node determines whether the service query apparatus needs to reply with query result information, so that not all service query apparatuses sending a first service query request message send query result information, which can avoid repeatedly sending query result information if multiple service query apparatuses receive a query request message sent by a same station, thereby reducing data that is transmitted between the station and the service node by using the service query apparatuses, and reducing transmission resources.

In a specific embodiment, the first service query request message that is sent by the output apparatus under control from the processor further includes: load indication information of the service query apparatus, and/or signal strength indication information of receiving a query request message by the service query apparatus, so that the service node determines, according to the signal strength indication information and/or the load indication information, an access point that sends the query result information; and/or the first service query request message that is sent by the output apparatus under control from the processor further includes a session identity, and in this case, when the input apparatus receives the query result information and the session identity that are sent by the service node, the output apparatus is controlled to send the query result information to the station in response to a query request message corresponding to the session identity.

In another specific embodiment, the processor is further configured to send connection information to the station, where the connection information includes a service node identity. Specifically, the processor may control the output apparatus to send a beacon frame, where the beacon frame includes identity information of a service node connected to the service query apparatus; or when the input apparatus receives a probe request frame sent by the station, control the output apparatus to send a probe response frame to the station, where the probe response frame includes identity information of a service node connected to the service query apparatus.

Moreover, the input apparatus in this embodiment is further configured to receive a query request message that is sent by the station in a multicast or broadcast manner, where the query request message further includes a bit table, the bit table includes bit information corresponding to one or more access points, and bit information that is corresponding to the service query apparatus and in the bit table is information that is obtained by the station according to address information of the service query apparatus by using a hash algorithm. Moreover, the input apparatus is further configured to receive a query request message that is sent by the station in a unicast manner.

In this embodiment, after the processor controls the output apparatus to send the connection information, if the input apparatus receives the query request message, and if the bit information that is corresponding to the service query apparatus and in the bit table included in the query request message indicates performing service query, the processor controls the output apparatus to perform the step of sending a first service query request message to a service node. If the input apparatus receives the query request message that is sent in the unicast manner, the processor directly controls the output apparatus to perform the step of sending a first service query request message to a service node.

### Device Embodiment 8 of the Present Invention

A service query apparatus, namely the foregoing access point, is provided. A structure of the service query apparatus is similar to the structure of the service query apparatus shown in the foregoing FIG. 16, where units in this embodiment may perform service query according to the method described in the foregoing Method Embodiment 4. The service query apparatus includes: a memory, a processor, an input apparatus, and an output apparatus that are separately connected to a bus.

The memory is configured to store data input from the input apparatus, and may further store information such as a file necessary for the processor to process data. The input apparatus and the output apparatus are ports of the service query apparatus for communicating with another device.

The processor is configured to control the output apparatus to send connection information to a station, where the connection information includes a service node identity, so that the station determines at least one query access point according to one or more access points that send the connection information, and sends a query request message, where the connection information sent by the multiple access points includes a same service node identity; and when the input apparatus receives the query request message sent by the station, where the query request message includes a station identity of the station and requested service information, and if the service query apparatus is the query access point determined by the station, perform service query according to the received query request message, or if the service query apparatus is not the query access point determined by the station, skip executing a service query operation. In this way, at least one query access point sending query result information is determined on a station side, and not all possible access points need to reply with the query result information, which can avoid repeatedly sending query result information if multiple access points receive a query request message sent by a same station, thereby reducing data that is transmitted between the station and a service node by using the access points, and reducing transmission resources.

When controlling the output apparatus to send the connection information, the processor is specifically configured to control the output apparatus to send a beacon frame, where the beacon frame includes identity information of a service node connected to the service query apparatus; or is specifically configured to: when the input apparatus receives a probe request frame sent by the station, control the output apparatus to send a probe response frame to the station in response to the probe request frame, where the probe response frame includes identity information of a service node connected to the service query apparatus.

Moreover, when receiving the query request message, the input apparatus is specifically configured to receive the query request message that is sent by the station in a unicast manner, and therefore, the processor directly performs the step of performing service query according to the query request message; or if the input apparatus receives the query request message that is sent by the station in a multicast or broadcast manner, where the query request message further includes a bit table, if bit information that is corresponding to the service query apparatus and in the bit table indicates performing service query, the processor performs the step of performing service query according to the query request message, where the bit table includes bit information corresponding to one or more access points. The bit information that is corresponding to the service query apparatus and in the bit table is information that is obtained by the station according to address information of the service query apparatus by using a hash algorithm.

Further, when the processor performs service query, if the input apparatus receives the query request message that is sent in the unicast manner, the processor may add the requested service information in the query request message to a service query request message, and control the output apparatus to send the service query request message to the service node to perform service query; or if the input apparatus receives the query request message that is sent in the broadcast or multicast manner, the processor may execute the service query method according to steps 301 to 303 in the foregoing Method Embodiment 2, and details are not described herein again.

### Device Embodiment 9 of the Present Invention

The device embodiment of the present invention provides a station and a service query apparatus. For specific functions executed by the station and the service query apparatus, reference may be made to Method Embodiment 7.

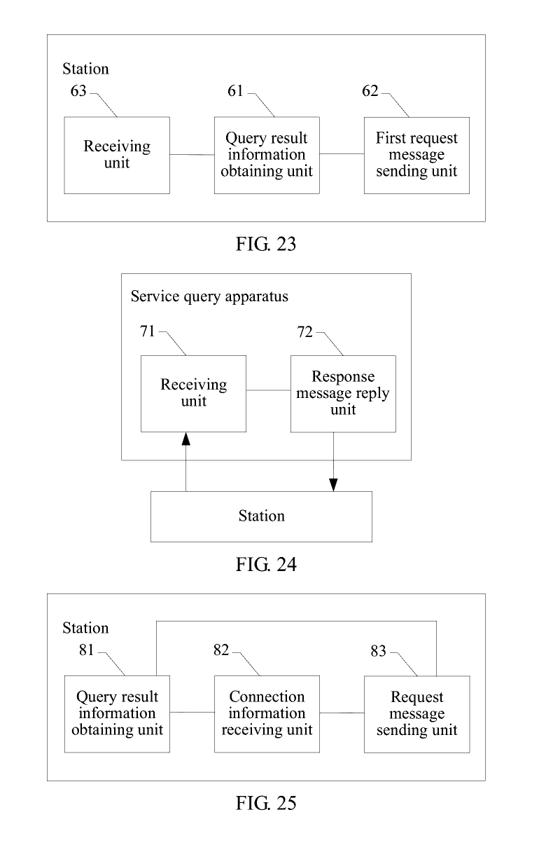

As shown in FIG. 23, the station may include:

a query result information obtaining unit 61, configured to obtain query result information of a first service node; and

a first request message sending unit 62, configured to: after the query result information obtaining unit 61 obtains the query result information of the first service node, send a first request message, where the first request message includes a node identity of the first service node and indication information related to the first service node; and the indication information is used for indicating that the station has obtained the query result information of the first service node, and/or the indication information is used for indicating a manner in which a first access point replies to the first request message with respect to the first service node, so that the first access point replies with a response message according to the first request message, where the first access point is an access point that receives the first request message and that is connected to the first service node.

The reply manner may specifically be: no reply or a simple reply.

Specifically, the query result information includes the node identity of the first service node; or

the station further includes a receiving unit 63, configured to: before the query result information obtaining unit 61 obtains the query result information of the first service node, receive a beacon frame sent by at least one access point, where the beacon frame includes the node identity of the first service node; or configured to: before the query result information obtaining unit 61 obtains the query result information of the first service node, receive a first probe response frame that is sent by at least one access point in response to a first probe request frame, where the first probe response frame includes the node identity of the first service node; or configured to: before the query result information obtaining unit 61 obtains the query result information of the first service node, receive a third service query response message that is sent by at least one access point in response to a third service query request message, where the third service query response message includes the node identity of the first service node.

Further, the first request message may specifically be a second probe request frame or a fourth service query request message that includes the node identity of the first service node and the instruction information related to the first service node.

FIG. 24 shows a service query apparatus provided in an embodiment of the present invention, where the service query apparatus is a first access point and may include:

a receiving unit 71, configured to receive a first request message sent by a station, where the first request message is sent by the station after the station obtains query result information of a first service node; the first request message includes a node identity of the first service node and indication information related to the first service node; and the indication information is used for indicating that the station has obtained the query result information of the first service node, and/or the indication information is used for indicating a manner in which the first access point replies to the first request message with respect to the first service node; and

a response message reply unit 72, configured to reply with a response message according to the first request message; where

the first access point is an access point that receives the first request message and that is connected to the first service node.

Specifically, the reply manner is specifically: no reply or a simple reply.

The response message reply unit 72 is specifically configured to skip replying or simply reply to the station with the response message with respect to the first service node according to the indication information in the first request message.

### Device Embodiment 10 of the Present Invention

The device embodiment of the present invention provides a station. For specific functions executed by the station, reference may be made to Method Embodiment 8.

As shown in FIG. 25, the station may include:

a query result information obtaining unit 81, configured to obtain query result information of a first service node;

a connection information receiving unit 82, configured to: after the query result information obtaining unit 81 obtains the query result information of the first service node, receive at least one piece of connection information sent by at least one access point connected to the first service node, where each piece of connection information in the at least one connection information includes a node identity of the first service node; and

a request message sending unit 83, configured to skip sending a request message to the at least one access point to request the query result information of the first service node.

Specifically, the query result information includes the node identity of the first service node; or

the connection information receiving unit 82 is further configured to: before the query result information obtaining unit 81 obtains the query result information of the first service node, receive a beacon frame sent by at least one access point, where the beacon frame includes the node identity of the first service node; or configured to: before the query result information obtaining unit 81 obtains the query result information of the first service node, receive a third probe response frame that is sent by at least one access point in response to a third probe request frame, where the third probe response frame includes the node identity of the first service node; or configured to: before the query result information obtaining unit 81 obtains the query result information of the first service node, receive a fifth service query response message that is sent by at least one access point in response to a fifth service query request message, where the fifth service query response message includes the node identity of the first service node.

Further, the connection information receiving unit 82 is specifically configured to: after the query result information obtaining unit 81 obtains the query result information of the first service node, receive a beacon frame sent by the at least one access point, where the beacon frame includes the connection information; or

receive a fourth probe response frame that is sent by the at least one access point in response to a fourth probe request frame, where the fourth probe response frame includes the connection information; or

receive a sixth service query response message that is sent by the at least one access point in response to a sixth service query request message, where the sixth service query response message includes the connection information.

### Device Embodiment 11 of the Present Invention

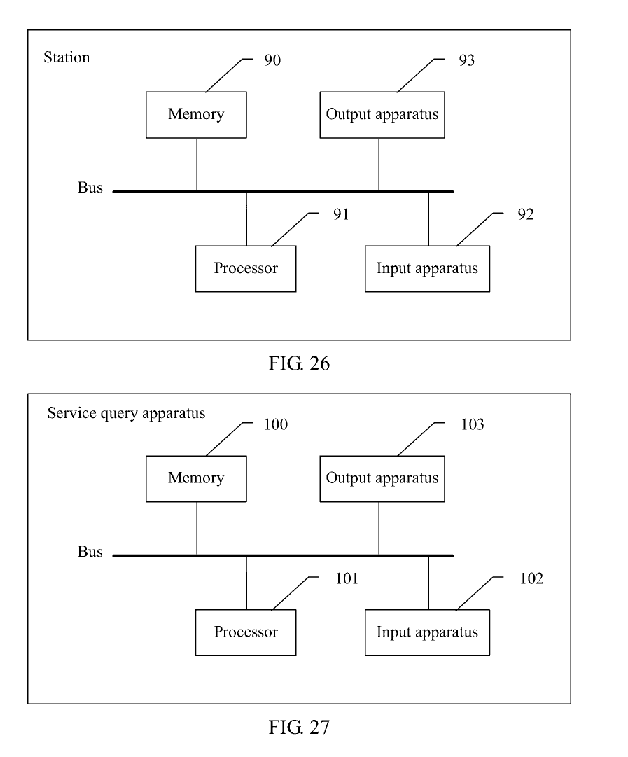

The device embodiment of the present invention provides a station. A schematic structural diagram is shown in FIG. 26, where units in this embodiment may perform service query according to the method described in the foregoing Method Embodiment 7. The station includes: a memory 90, a processor 91, an input apparatus 92, and an output apparatus 93 that are separately connected to a bus.

The memory 90 is configured to store data input from the input apparatus 92, and may further store information such as a file necessary for the processor 91 to process data. The input apparatus 92 and the output apparatus 93 are ports of the station for communicating with another device.

The input apparatus 92 is configured to obtain query result information of a first service node.

The processor 91 is configured to: after the input apparatus 92 obtains the query result information of the first service node, control the output apparatus 93 to send a first request message, where the first request message includes a node identity of the first service node and indication information related to the first service node; and the indication information is used for indicating that the station has obtained the query result information of the first service node, and/or the indication information is used for indicating a manner in which a first access point replies to the first request message with respect to the first service node, so that the first access point replies with a response message according to the first request message, where the first access point is an access point that receives the first request message and that is connected to the first service node.

### Device Embodiment 12 of the Present Invention

The device embodiment of the present invention provides a service query apparatus, where the service query apparatus may be a first access point. A schematic structural diagram is shown in FIG. 27, where units in this embodiment may provide service query according to the method described in the foregoing Method Embodiment 7. The service query apparatus includes: a memory 100, a processor 101, an input apparatus 102, and an output apparatus 103 that are separately connected to a bus.

The memory 100 is configured to store data input from the input apparatus 102, and may further store information such as a file necessary for the processor 101 to process data. The input apparatus 102 and the output apparatus 103 are ports of an access point for communicating with another device.

The input apparatus 102 is configured to receive a first request message sent by a station.

The processor 101 is configured to: after the input apparatus 102 receives the first request message sent by the station, where the first request message is sent by the station after the station obtains query result information of a first service node, the first request message includes a node identity of the first service node and indication information related to the first service node, and the indication information is used for indicating that the station has obtained the query result information of the first service node, and/or the indication information is used for indicating a manner in which the first access point replies to the first request message with respect to the first service node, control, according to the first request message, the output apparatus 103 to reply with a response message, where the first access point is an access point that receives the first request message and that is connected to the first service node. The processor 101 is specifically configured to control, according to the indication information in the first request message, the output apparatus 103 not to reply or to simply reply with the response message with respect to the first service node.

### Device Embodiment 13 of the Present Invention

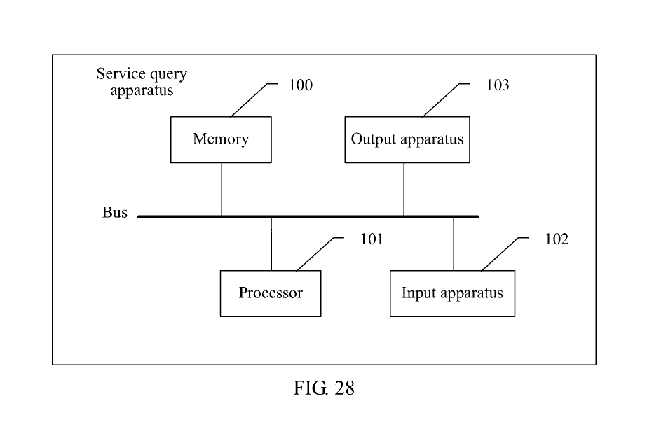

The device embodiment of the present invention provides a station. A schematic structural diagram is shown in FIG. 28, where units in this embodiment may provide service query according to the method described in the foregoing Method Embodiment 8. The station includes: a memory 110, a processor 111, an input apparatus 112, and an output apparatus 113 that are separately connected to a bus.

The memory 110 is configured to store data input from the input apparatus 112, and may further store information such as a file necessary for the processor 111 to process data. The input apparatus 112 and the output apparatus 113 are ports of an access point for communicating with another device.

The input apparatus 112 is configured to: after obtaining query result information of a first service node, receive at least one piece of connection information sent by at least one access point connected to the first service node, where each piece of connection information in the at least one piece of connection information includes a node identity of the first service node.

The processor 111 is configured to control, according to the query result information that is of the first service node and obtained by the input apparatus 112 and the received connection information, the output apparatus 113 not to send a request message to the at least one access point to request the query result information of the first service node.

A system embodiment of the present invention provides a service query system, including multiple access points and a service node. A structure of the access point may be similar to the structure of the service query apparatus shown in FIG. 13 in the foregoing Device Embodiment 3, and a structure of the service node may be similar to the structure of the service query apparatus described in the foregoing Device Embodiment 1, which are not described herein again. The service node and one access point of the multiple access points may be deployed on a same physical device, for example, in the system shown in FIG. 1b; or may be deployed on different physical devices, for example, in the system shown in FIG. 1a.

A system embodiment of the present invention provides another service query system, including multiple access points and a service node. A structure of the access point may be similar to the structure of the service query apparatus described in the foregoing Device Embodiment 7, and a structure of the service node may be similar to the structure of the service query apparatus described in the foregoing Device Embodiment 5, which are not described herein again. The service node and one access point of the multiple access points may be deployed on a same physical device, for example, in the system shown in FIG. 1b; or may be deployed on different physical devices, for example, in the system shown in FIG. 1a.

A system embodiment of the present invention provides a service query system, including a station, multiple access points, and a service node. A structure of the station may be similar to the structure of the station described in the foregoing Device Embodiment 2, and a structure of the access point may be similar to the structure of the service query apparatus shown in FIG. 14 in the foregoing Device Embodiment 3, or the structure of the service query apparatus described in the foregoing Device Embodiment 4. Further, a structure of the service node may be similar to the structure of the service query apparatus described in the foregoing Device Embodiment 1, and details are not described herein again. The service node and one access point of the multiple access points may be deployed on a same physical device, for example, in the system shown in FIG. 1b; or may be deployed on different physical devices, for example, in the system shown in FIG. 1a.

A system embodiment of the present invention provides a service query system, including a station, multiple access points, and a service node. A structure of the station may be similar to the structure of the station described in the foregoing Device Embodiment 6, and a structure of the access point may be similar to the structure of the service query apparatus described in the foregoing Device Embodiment 8. Further, a structure of the service node may be similar to the structure of the service query apparatus described in the foregoing Device Embodiment 5, and details are not described herein again. The service node and one access point of the multiple access points may be deployed on a same physical device, for example, in the system shown in FIG. 1b; or may be deployed on different physical devices, for example, in the system shown in FIG. 1a.

It should be noted that the “first”, “second”, . . . , and the like in the embodiments of the present invention are merely used for distinguishing and do not have a specific meaning. For the device embodiments, reference may be made to the descriptions of the corresponding method embodiments, and details are not described again.

A person of ordinary skill in the art may understand that all or some of the steps of the methods in the embodiments may be implemented by a program instructing related hardware. The program may be stored in a computer readable storage medium. The storage medium may include: a read-only memory (ROM), a random-access memory (RAM), a magnetic disk, or an optical disc.

The foregoing describes in detail the service query method, apparatus and system, and the station provided in the embodiments of the present invention. In this specification, specific examples are used to describe the principle and implementation manners of the present invention, and the description of the embodiments is only intended to help understand the method and core idea of the present invention. Meanwhile, a person of ordinary skill in the art may, based on the idea of the present invention, make modifications with respect to the specific implementation manners and the application scope. Therefore, the content of this specification shall not be construed as a limitation to the present invention.

What is claimed is:

1. A service query method, the method comprising:
receiving, by a service node, a first service query request message sent by at least one access point, wherein the first service query request message comprises a station identity and requested service information;
determining, by the service node, a first access point according to the at least one access point;
sending, by the service node, query result information to the first access point, so that the first access point sends the query result information to a station corresponding to the station identity, wherein the query result information is obtained by the service node according to the requested service information in the first service query request message; and
when the at least one access point comprises multiple access points, sending instruction information to another access point than the first access point in the at least one access point, wherein the instruction information is used for instructing the another access point not to send the query result information.

2. The method according to claim 1, wherein:
sending the query result information to the first access point, so that the first access point sends the query result information to a station corresponding to the station identity comprises:
sending a first service query response message to the first access point, wherein the first service query response message comprises the query result information, so that the first access point sends the query result information to the station according to the first service query response message; and
sending the instruction information to another access point than the first access point in the at least one access point comprises:
sending a second service query response message to the another access point, wherein the second service query response message comprises the instruction information, and the instruction information is used for instructing the another access point not to send the query result information, so that the another access point does not send the query result information according to the second service query response message.

3. The method according to claim 1, wherein:
when the first service query request message further comprises load indication information of the access point, and/or signal strength indication information of receiving a query request message by the access point, determining, by the service node, the first access point in the at least one access point comprises:
determining the first access point according to the signal strength indication information and/or the load indication information.

4. The method according to claim 1, wherein:
when the first service query request message further comprises a session identity, sending, by the service node, the query result information to the first access point comprises:
sending the session identity and the query result information to the first access point, so that the first access point sends the query result information to the station in response to a query request message corresponding to the session identity, wherein the query request message is sent by the station and received by the first access point.

5. The method according to claim 1, wherein the method further comprises:
storing, by the service node, the first service query request message and/or the query result information; and
when the service node receives a second service query request message that is sent by the station through a second access point, if requested service information in the second service query request message is consistent with the requested service information in the stored first service query request message, or if query result information of the second service query request message is consistent with the stored query result information, sending, by the service node, the instruction information to the second access point, wherein the instruction information is used for instructing the second access point not to send the query result information to the station.

6. A service query method, the method comprising:
receiving, by a station, connection information sent by an access point, wherein the connection information comprises a service node identity;
determining, by the station, at least one query access point according to one or more access points that send the connection information, wherein the connection information sent by the multiple access points comprises a same service node identity; and
sending, by the station, a query request message to the at least one query access point, wherein the query request message comprises a station identity of the station and requested service information, so that the at least one query access point initiates, according to the query request message, service query to a service node corresponding to the same service node identity.

7. The method according to claim 6, wherein receiving, by the station, the connection information sent by the access point comprises:
receiving, by the station, a beacon frame sent by the access point, wherein the beacon frame comprises identity information of a service node connected to the access point; or
receiving, by the station, a probe response frame that is sent by the access point in response to a probe request frame, wherein the probe response frame comprises identity information of a service node connected to the access point.

8. The method according to claim 6, wherein sending, by the station, the query request message to the at least one query access point comprises:
sending, by the station, the query request message to the at least one query access point in a unicast manner, so that the at least one query access point sends query result information to the station; or
sending, by the station, the query request message in a multicast or broadcast manner, wherein the query request message further comprises a bit table, and using bit information that is corresponding to the at least one query access point and in the bit table to indicate performing service query, wherein the bit table comprises bit information corresponding to the one or more access points.

9. The method according to claim 8, wherein the bit information that is corresponding to the at least one query access point and in the bit table is information that is obtained according to address information of the at least one query access point by using a hash algorithm.

10. A service query method, the method comprising:
sending, by an access point, a first service query request message to a service node, wherein the first service query request message comprises a station identity and requested service information;
when receiving query result information sent by the service node, sending, by the access point, the query result information to a station corresponding to the station identity, wherein the query result information is obtained by the service node according to the requested service information in the first service query request message; and
when receiving instruction information sent by the service node, wherein the instruction information is used for instructing the access point not to send the query result information, skipping sending, by the access point, the query result information, or sending information other than the query result information to the station.

11. The method according to claim 10, wherein:
the first service query request message further comprises:
load indication information of the access point, and/or signal strength indication information of receiving a query request message by the access point, so that the service node determines, according to the signal strength indication information and/or the load indication information, an access point that sends the query result information; and/or
a session identity, and when the access point receives the query result information and the session identity that are sent by the service node, sending the query result information to a station corresponding to the station identity comprises:
sending the query result information to the station in response to a query request message corresponding to the session identity.

12. The method according to claim 10, wherein before sending, by the access point, the first service query request message to the service node, the method further comprises:
sending, by the access point, connection information to the station, wherein the connection information comprises a service node identity.

13. The method according to claim 12, wherein after sending, by the access point, the connection information to the station, the method further comprises:
after the access point receives the query request message that is sent by the station in a unicast manner, performing the step of sending, by an access point, a first service query request message to a service node; or
receiving, by the access point, the query request message that is sent by the station in a multicast or broadcast manner, wherein the query request message further comprises a bit table, and the bit table comprises bit information corresponding to one or more access points; and
when bit information that is corresponding to the access point and in the bit table indicates performing service query, performing the step of sending, by an access point, a first service query request message to a service node.

14. The method according to claim 13, wherein the bit information that is corresponding to the access point and in the bit table is information that is obtained by the station according to address information of the access point by using a hash algorithm.

15. A service query method, the method comprising:
sending, by an access point, connection information to a station, wherein the connection information comprises a service node identity, so that the station determines at least one query access point according to one or more access points that send the connection information, and sends a query request message, wherein the connection information sent by the multiple access points comprises a same service node identity;
receiving, by the access point, the query request message sent by the station, wherein the query request message comprises a station identity of the station and requested service information; and
when the access point is the query access point determined by the station, initiating, by the access point according to the query request message, service query to a service node corresponding to the same service node identity.

16. The method according to claim 15, wherein sending, by the access point, the connection information to the station comprises:
sending, by the access point, a beacon frame, wherein the beacon frame comprises identity information of a service node connected to the access point; or
when receiving a probe request frame sent by the station, sending, by the access point, a probe response frame to the station in response to the probe request frame, wherein the probe response frame comprises identity information of a service node connected to the access point.

17. The method according to claim 15, wherein receiving, by the access point, the query request message sent by the station comprises:
receiving, by the access point, the query request message that is sent by the station in a unicast manner, and performing the step of performing service query according to the query request message; or
receiving, by the access point, the query request message that is sent by the station in a multicast or broadcast manner, wherein the query request message further comprises a bit table, and if bit information that is corresponding to the access point and in the bit table indicates performing service query, performing the step of performing service query according to the query request message, wherein the bit table comprises bit information corresponding to one or more access points.

18. The method according to claim 17, wherein the bit information that is corresponding to the access point and in the bit table is information that is obtained by the station according to address information of the access point by using a hash algorithm.

19. A service query apparatus, comprising:
a receiver configured to receive a first service query request message sent by at least one access point, where the first service query request message includes a station identity and requested service information;
a processor operatively coupled to the receiver, the processor configured to determine a first access point according to the at least one access point and obtain a query result information according to the requested service information in the first service query request message received by the receiver; and
a transmitter operatively coupled to the processor, the transmitter configured to send the query result information to the first access point, so that the first access point sends the query result information to a station corresponding to the station identity, and send instruction information to another access point than the first access point in the at least one access point when the at least one access point includes multiple access points, wherein the instruction information is used for instructing the another access point not to send the query result information.

20. The service query apparatus of claim 19, wherein:
the service query apparatus stores the first service query request message and/or the query result information;
the receiver is further configured to:
receive a second service query request message that is sent by the station through a second access point; and
the transmitter is configured to:
send the instruction information to the second access point when requested service information in the second service query request message is consistent with the requested service information in the stored first service query request message, or when query result information of the second service query request message is consistent with the stored query result information, wherein the instruction information is used for instructing the second access point not to send the query result information to the station.
